(19) United States
(12) Patent Application Publication
(10) Pub. No.: US 2025/0346027 A1
(43) Pub. Date: Nov. 13, 2025

(54) METHODS OF JOINING DISSIMILAR MATERIALS

(71) Applicants: OHIO STATE INNOVATION FOUNDATION, Columbus, OH (US); UNIVERSITY OF MARYLAND, College Park, MD (US)

(72) Inventors: Alan LUO, Westerville, OH (US); Matt HARTSFIELD, Columbus, OH (US); Liangbing HU, Rockville, MD (US); Yu LIU, Berwyn Heights, MD (US)

(21) Appl. No.: 18/872,134

(22) PCT Filed: Jun. 6, 2023
(86) PCT No.: PCT/US2023/024620

§ 371 Date: Dec. 5, 2024

Related U.S. Application Data
(60) Provisional application No. 63/365,947, filed on Jun. 6, 2022.
(60) Provisional application No. 63/455,727, filed on Mar. 30, 2023.

(51) Int. Cl. B32B 37/12; B32B 7/08; B32B 7/12; B32B 15/10; B32B 38/00

(52) U.S. Cl. CPC B32B 37/12; B32B 7/08; B32B 7/12; B32B 15/10; B32B 2037/1253; B32B 2038/0096; B32B 2250/02

(57) ABSTRACT

Disclosed herein are methods of joining dissimilar materials.

### STATEMENT OF GOVERNMENT SUPPORT

This invention was made with government support under DEAR0001025 awarded by the Department of Energy. The government has certain rights in the invention.

### BACKGROUND

Wood materials have been improved, i.e., chemically altered and densified, to provide significantly higher strength than natural wood, comparable to metallic materials commonly used in structural applications in automotive and other transportation industries. In order to make wood materials in structural applications in manufacturing, they need to be joined with dissimilar materials such as metals. Improved methods for joining dissimilar materials are needed. The devices and methods discussed herein address these and other needs.

### SUMMARY

In accordance with the purposes of the disclosed devices and methods as embodied and broadly described herein, the disclosed subject matter relates to methods of joining dissimilar materials, devices comprising the dissimilar materials joined by said methods, and methods of use of joined dissimilar materials made by said methods.

Additional advantages of the disclosed devices and methods will be set forth in part in the description which follows, and in part will be obvious from the description. The advantages of the disclosed devices and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

FIG. 1 is a flow chart of densified wood manufacturing.

FIGS. 2A-2C are photographs of (FIG. 2A) natural wood, (FIG. 2B) delignified wood and (FIG. 2C) densified wood. In the first embodiment, natural wood (FIG. 2A) and the chemical solution are put into a 2L reactor, and heated at 100-180° C. for 1 to 4 hours to obtain the delignified wood (FIG. 2B). In the second embodiment, the delignified wood is pressed into super wood (FIG. 2C) using a presser under the pressure of 5-20 MPa at 105° C.

FIG. 3A is a tensile stress-strain curves for natural wood and super wood. (FIG. 3B) Compared with natural wood (54.3±4.7 MPa), the strength of super wood (610.5±15.9 MPa) has greatly improved about 11 times.

FIG. 4 is a schematic of Lap Shear Adhesive Stack dimensions.

FIG. 5 are photographs of riveted Superwood-Aluminum stack cross-section.

FIG. 6 are photographs of mechanical property and failure surfaces of superwood-aluminum stack with adhesive and rivet.

FIG. 7 is a schematic showing the proposed bonding mechanisms between aluminum and the superwood in this investigation. The methacrylate adhesive was selected because the MMA polymer bonds to the aluminum and its surface oxides through hydrogen bonding and carboxylate ionic bonding (Pletincx et al., 2017). It also adheres to the cellulose and lignin in the superwood substrate by hydrogen/chemical bonding and through penetrating the pores to create a mechanical interlock (Gardner and Tajvidi, 2016). The joining process development and failure mechanism discussions in this investigation are based in bonding mechanisms depicted in FIG. 7.

FIGS. 8A-8C show joint design. (FIG. 8A) assembled joint; (FIG. 8B) no surface preparation (NS) superwood model; (FIG. 8C) oriented polishing superwood model with polishing all oriented transverse to the fiber direction (OS); (FIG. 8D) randomly oriented polishing model (RS); and (FIG. 8E) adhesive application. The adhesive is applied in an x-pattern to one substrate, then the other substrate is placed on top of the adhesive and pressed to spread the adhesive across the entire surface area of the joint.

FIG. 9A is a photograph of natural wood sample; (FIG. 9B) SEM image of the natural wood sample perpendicular to the tree growth (L) direction; (FIG. 9C) SEM image of the natural wood sample in the RL plane, revealing the cross-section view of the lumina along the L direction; (FIG. 9D) photograph of super wood; (FIG. 9E) SEM image of the densified wood in the RT plane, showing the fully collapsed lumina; and (FIG. 9F) SEM image of the densified wood in the RL plane shows the dense laminated structure.

FIG. 10A is a graph of maximum joint strength of aluminum-to-superwood joints achieved in this study, compared to aluminum-to-aluminum, natural wood-to-wood, and superwood-to-superwood joint strengths.

FIG. 10B is a graph of maximum joint strength of aluminum-to-superwood joints achieved in this study, compared to aluminum-to-aluminum, natural wood-to-wood, and superwood-to-superwood joint strengths. Note: differences in adhesive. Superwood-to-Al, natural wood-to-natural wood, superwood-to-superwood all have adhesives with average shear strength of 16.5 MPa. Al to Al has adhesive with average shear strength of 23.4 MPa.

FIG. 11A-11F show failure surfaces and load-displacement curves of (FIG. 11A) no surface treatment 0 N; ((FIG. 11B) no surface treatment 1334 N; (FIG. 11C) oriented scratches 0 N; (FIG. 11D) oriented scratches 667 N; (FIG. 11E) oriented scratches 1334 N; and (FIG. 11F) random scratches 0 N. Each show shallow wood failure, occurring near the surface of the superwood and showing fracture paths unaffected by the grain structure. The shallow wood failure here largely occurs as a thin coating of wood fiber similar to sawdust left on the aluminum side of the joint, seen most clearly in FIG. 11A, with some larger sections of wood staying intact, such as in FIG. 11F where two thin strips can be seen pulled from the surface of the superwood but still maintain structure. It also shows areas opposite those two strips where no wood can be seen at the adhesive surface, again showing shallow failure.

FIGS. 12A-12B show failure surface and load-displacement curve of random scratches at 667N (FIG. 12A) and failure surface and load-displacement curve of random scratches at 1334 N (FIG. 12B). Both show deep wood failure, with (FIG. 12A) showing a fracture path likely influenced by the grain structure and (FIG. 12B) showing failure deep enough into the superwood that the surface of the adhesive is completely coated in superwood fibers. This is most clearly seen in FIG. 12A where alongside the large section of wood that is removed from the superwood surface while maintaining structural integrity on the superwood side of the joint, large fibers can be seen on the aluminum side, the largest of which is in the center of the join. These fibers are more substantial than the shallow wood failure, where the surfaces resemble sawdust. In FIG. 12B the wood surface does not have the same amount of wood partially removed from the superwood bulk, but the wood attached to the aluminum side of the joint is intact enough and thick enough that an impression of the grain structure can be seen, most obvious in the darker band of material near the center of the joint.

FIG. 13A is a schematic of double-lap shear sample. FIG. 13B) Double Lap Shear failure surface and load-displacement curve of random scratches and 1334 N clamping force. The sample shows deep wood failure with failure occurring between within each of the two pieces of superwood, the failure at the top of the sample failing in the superwood shown here on the left, and failure at the bottom of the sample occurring in the superwood shown on the left. (FIG. 13C) Force-displacement curve of characteristic double-lap shear sample.

FIG. 14A. Aluminum patterned using vice and hammer; (FIG. 14B) failure surface of sample with patterned aluminum and sanded superwood; and (FIG. 14C) load-displacement of patterned aluminum.

FIG. 15A) Photograph of two samples (RS1334) examined under SEM; FIG. 15B) closer image of left sample on both aluminum and superwood side of failure; FIG. 15C) cutoff failure surfaces for SEM imaging; FIGS. 15D-15F) left sample at various magnifications; and FIGS. 1515I) right sample at various magnifications.

FIG. 16. SPR process and cross section elements that determine joint quality.

FIG. 17. Left to right, J, P, R rivet.

FIG. 18. Left to right: High speed J rivet; low speed J rivet; High speed P rivet; low speed P rivet.

FIG. 19. Low speed rivets curves. J seems to outperform P, but it is close and the low speed are unreliable due to cracking.

FIG. 20. High speed rivet curves.

FIG. 21. Uncured rivbond. Almost all adhesive was pressed out of joint.

FIG. 22. Cured rivbond joint. Shows typical failure with layers of superwood attached to adhesive and rivet pull out.

FIG. 23. Cured vs uncured adhesive curves.

FIG. 24. Rivet, rivbond, and adhesive comparison.

FIG. 25. Top sheet tearing—the rivet is pulled through the top sheet.

FIG. 26. Rivet pull out in conjunction with top sheet tearing.

FIG. 27. Crack creation.

FIG. 28. Crack expansion.

FIG. 29A-29D. Cracked samples with illustration of crack pattern through thickness of superwood.

FIG. 30. Curves for different cracking patterns.

FIG. 31. Low Speed Rivet cross section J, P, R. All buckled, poor joint caused rivets to fall from joint during sectioning.

FIG. 32. Left: Rivet, Right: Rivbond. Marked with head height, flare, and bottom thickness.

FIG. 33. Low speed rivet showing buckling behavior.

FIG. 34. High speed rivet showing no buckling and a proud head height.

FIG. 35. high-speed vs low-speed load-displacement curves. High-speed show much higher energy absorption, with a maximum load of 1070 N compared to low-speed with a max load of 210N.

FIG. 36. Load-extension curves for pure rivet, pure adhesive, and rivbonding (high-speed).

### DETAILED DESCRIPTION

The devices and methods described herein may be understood more readily by reference to the following detailed description of specific aspects of the disclosed subject matter and the Examples included therein.

Before the present devices and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Disclosed herein are methods of joining dissimilar materials. For example, disclosed herein are methods of joining dissimilar materials, the methods comprising joining a first material to a second material using adhesive bonding, self-piercing riveting, or a combination thereof; wherein the first material and the second material are different (e.g., dissimilar).

In some examples, the first material comprises wood, such as superwood.

In some examples, the second material comprises a metal (e.g., a metal alloy). In some examples, the second material comprises aluminum, magnesium, steel, or a combination thereof. In some examples, the second material comprises aluminum (e.g., A15754).

In some examples, the method comprises adhesive bonding. In some examples, adhesive bonding comprises applying an adhesive to at least a portion of the first material and/or the second material, contacting said portion with the other material (e.g., single lap, double lap), optionally applying pressure, and allowing the adhesive to cure. In some examples, the method further comprises using spacers to ensure an even layer of adhesive. In some examples, the method further comprises preparing the first material and/or the second material before applying the adhesive, for example cleaning, priming, etching, polishing, sanding, patterning, etc., or a combination thereof.

In some examples, the adhesive comprises an acrylic adhesive, such as a methacrylate adhesive (e.g., a methyl methacrylate adhesive, such as Plexus MA832). In some examples, the adhesive comprises a time-curing adhesive, a heat-curing adhesive, or a combination thereof.

In some examples, the method comprises self-piercing riveting. In some examples, the method comprises stacking the first material and the second material, placing the stack on the riveting machine with the first material facing the rivet insertion mechanism and the second material facing the die, and riveting the stack with a self-piercing rivet.

In some examples, the self-piercing rivets comprise J rivets, P rivets, R rivets, or a combination thereof. In some examples, the self-piercing rivets comprise J rivets, P rivets, or a combination thereof.

In some examples, the self-piercing rivets are inserted with an insertion force of 20 kN or more (e.g., 25 kN or more, 30 kN or more, 35 kN or more, 40 kN or more, or 45 kN or more). In some examples, the self-piercing rivets are inserted with an insertion force of 50 kN or less (e.g., 45 kN or less, 40 kN or less, 35 kN or less, 30 kN or less, or 25 KN or less). The force at which the self-piercing rivets are inserted can range from any of the minimum values described above to any of the maximum values described above. For example, the self-piercing rivets are inserted with an insertion force of from 20-50 kN (e.g., from 20 to 35 kN, from 35 to 50 kN, from 10 to 20 kN, from 30 to 40 kN, from 40 to 50 kN, from 30 to 50 kN, from 20 to 40 kN, or from 25 to 45 kN). In some examples, the self-piercing rivets are inserted at high speed (˜145 mm/s) or low speed (˜60 mm/s). In some examples, the self-piercing rivets are inserted at high speed.

In some examples, the self-piercing rivets have a 3 mm diameter and a flare of 0.1 mm or more (e.g., 0.3 mm or more) after riveting.

In some examples, the head of the self-piercing rivets are substantially flush with surface of first material after riveting.

In some examples, the self-piercing rivet composition and dimensions are chosen in view of the first material (composition and thickness) and the second material (composition and thickness).

In some examples, the method comprises adhesive bonding and self-piercing riveting (e.g., rivbonding). In some examples, self-piercing riveting is performed after adhesive bonding. In some examples, the adhesive is cured before performing self-piercing riveting. In some examples, the method provides improved fatigue results.

Also disclosed herein are devices comprising the dissimilar materials joined by the any of methods disclosed herein.

Also disclosed herein are methods of use of the dissimilar materials joined by any of the methods disclosed herein.

In some examples, the method comprises using the joined dissimilar materials for aerospace, defense and/or automotive industry applications. In some examples, the method comprises using the joined dissimilar materials in an automotive and/or aerospace application. In some examples, the method comprises using the joined dissimilar materials in an automotive application.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1-Dissimilar Material Joining of Superwood to Aluminum by Adhesive Bonding

Superwood is a densified wood product that shows promise as a lightweight and renewable alternative for metallic materials. In order for this high-performance new material to be used in multi-material products, it must be able to be joined with other major materials. For example, joining superwood to aluminum would provide key enabling technology for its use in automotive components since aluminum is presently a major lightweight material for such applications. In this paper, a methacrylate-based adhesive has been identified to provide high lap shear strength (7.5 MPa) for aluminum-to-superwood joints. The aluminum-to-superwood samples were prepared with different amounts of pre-polishing to create openings to the pores in the superwood so adhesive could penetrate into them and create a mechanical interlock, in addition to the hydrogen/chemical bonding at the surface between the methyl methacrylate (MMA) in methacrylate-based adhesive and the cellulose in superwood. For aluminum samples, a thin layer (typically a few nanometers) of oxide film on the surfaces provides hydrogen/chemical bond to MMA structure in the adhesive layer. The failure strength of the superwood-to-aluminum joint sample is about 50% higher than that of natural wood to natural wood joint sample, and comparable to that of aluminum-to-aluminum joint sample.

Superwood is a lightweight and high-performance material created by chemically treating natural wood to partially remove lignin and compressing the treated wood into a much denser material. This creates a significantly stronger structural material than natural wood while remaining a renewable resource (Song et al., 2018). An important step in bringing this material to an application stage is to develop technology and best practices for joining superwood to other major materials such as aluminum alloys. To fully utilize the excellent properties of the superwood material, advanced joining techniques must be developed for applications.

There are many methods of joining similar and dissimilar materials, generally classified as mechanical and chemical joining methods. Mechanical joints include screws, rivets and mechanical interlocks, while chemical joints involve various types of adhesives. Each method has its advantages and limitations.

With mechanical joining, a joint is created in discrete intervals rather than along the entire contact surface (Barnes and Pashby, 2000). This allows for ease of operation, but can create stress concentrators in the joint. Many such methods are available, but have drawbacks such as stress concentrators or requiring a narrow range of moisture content to create a joint (Luder et al., 2014). Another option is friction stir-welding, which has successfully been used to join aluminum to wood, but has the drawback of using an interfacial material to aid in joining (Xie et al., 2020) as week as being dependent on the fiber angle of the wood (Yin et al., 2022).

Screws are often the easiest joining method to implement, but leave the tips of the screws protruding from the other side of the joint in thin applications, where they can be an issue if they come into contact with other parts in an assembly. Riveting avoids this issue, but requires predrilling holes for the rivets in blind riveting or access to both sides of the joint in self-piercing riveting. Mechanical interlocks such as dovetail joints are frequently used in carpentry when joining natural wood but require precise cutting of the interlock shape to avoid additional stress concentrators and to create a firm bond. In addition, many forms of mechanical interlock need additional adhesive or mechanical joining to prevent the pieces from separating if force is applied in specific directions. Another mechanical interlock option would be flat-clinching, which has been studied with natural wood, however the wood used in the joints needed moisture content within a 4% range in order to create a functioning joint, which may be narrower in denser wood (Lüder et al., 2014).

Adhesive joining can mitigate many of the above issues associated with mechanical joints. With adhesive joining, the joint is comprised of the entire contact surface, so there are more uniform stress distributions compared to mechanical joints. Adhesives do have some pretreatment requirements depending on the adhesive and the materials, much as mechanical joints can require predrilling (Lunder et al., 2002). These can range from simple cleaning of the surface to needing to prime it with a second compound to which the adhesive can bond (Rushforth et al., 2002). Many types of pretreatment have been extensively tested for various metals such as aluminum. Pereira et al. (2010) reported etching with sodium dichromate-sulphuric acid or abrasive polishing to be more effective than a caustic etch or single cleaning of the surface with acetone. The abrasive polishing surface treatment is commonly found in literature, such as by David and Lazar (2003). The problem with adhesives is that unlike many mechanical fasteners, the same adhesive will not provide the same effect with different materials. There are many types of adhesives, such as epoxies, acrylics, and urethanes, each using different catalysts to create a bond (Ebnesajjad, 2011) or using interactions with the substrate to cure the polymer (Ebnesajjad, 2022). Epoxies are among the most widely used for structural applications, comprised of resin that interacts with a catalyst to bond to the substrate and harden (Ebnesajjad, 2011). Methacrylate acrylics are also common in metal joining, as metal actually speeds the curing process of the polymer by increasing the production of free radical catalysts (Ebnesajjad, 2022). Each of these has thousands of different adhesive formulations with each base structure.

All of these adhesives function differently in specific applications with specific materials, and while there are adhesives specifically designed for natural wood, none have yet been designed for the new superwood material. The lack of adhesives specific for the superwood substrate requires any attempt to join the material to either create a new adhesive or to find one that works well despite not being designed for the material. To choose an appropriate adhesive for aluminum to superwood bonding, a list of adhesives recommended for aluminum alloys was compiled. Then the other substrates the adhesives were well suited for were examined and a methacrylate adhesive used in the automotive industry was chosen, with compatible substrates including aluminum and steel as well as many types of polymers. The methacrylate also had the benefit of being time cured rather than heat cured. When examining heat curing adhesives for suitability with superwood, care needed taken that the heat would not exceed the ignition or degradation temperature of the superwood. Additionally, studies in natural wood have shown that density and mechanical properties changes in wood after heat treatment which could negatively affect the joint (Gong et al., 2010).

The methacrylate adhesive functions by using the initiators in part B of the 2-part compound to initiate free radical polymerization of the methyl-methacrylate (MMA) monomers into methyl methacrylate (MMA) polymers. These adhesives can solvate on most surfaces regardless of surface contaminants, as claimed by a manufacturer (Plexus Structural Adhesives, 2022). The specific formulation allows the monomers to solvate the substrate before curing begins. MMA adhesives are also used for their continued ability to function at full strength if the mixing ratio is slightly off, removing one component that could affect adhesive performance over multiple joints.

While superwood is an altered form of wood, it maintains similar structural makeup to natural wood, but the densification does collapse the pores in the superwood structure. These pores are used when creating a strong adhesive bond with natural wood substrates, with adhesive travelling through the pores to penetrate deeper within the material (Vick, 1999). The structure of superwood makes this bonding mechanism difficult to realize, so it is important to improve the quality of the surface for adhesive bonding. The surface preparation is one of the most well researched areas of natural wood adhesive joining, with published research in early literature (Selbo, 1975). In natural wood, it has been shown that the wettability of the surface has a strong correlation to the bond strength and is easily increased by abrading the surface. This also has the effect of removing surface contaminants that could interfere with the bonding (Ayrilmis et al., 2010). Care must be taken to avoid crushing and burnishing the surface when abrading. This type of damage is frequently seen when natural wood material is cut on less well-maintained machines as damage to saw teeth or dulling of the knives of a thickness planer cause the natural wood surface to have significantly reduced wettability and bond strength (Özçifçi and Yapici, 2008). The surface roughness of natural wood can be correlated to an increase of adhesion strength (Vitostyé et al., 2012). The treatment that the natural wood undergoes in the process of creating superwood decreases the surface roughness of the natural wood, as heating does in natural wood (Vitostyé et al., 2015). The precise roughness of the surface is difficult to characterize, being dependent on the structure of natural wood as it creates irregularities in the surface not due to any surface treatment, causing surface roughness comparisons between samples to be unreliable (Magoss, 2008). Another important area in quality of natural wood adhesive joints is the moisture effect on the joints. Excessive moisture in the natural wood can cause overpenetration of the adhesive, thinning the adhesive at the interface, while overly dry wood can resist wetting from the adhesive, preventing adhesive penetration (Vick, 1999). Less research has been done in the interface between the natural wood and adhesive and its failure mechanism. What has been performed shows that failure is partially caused by the cell wall swelling at the surface, which is dependent on both moisture content and whether the sample is old or new wood, as refers to growth stages in natural wood, as the cellular structure between the two differs (Frihart, 2005).

The goal of this research is to develop adhesive bonding technology for superwood, especially for dissimilar material joints to metallic materials for structural applications. One such application is automotive industry, where adhesives are commonly used in joining dissimilar materials (Pan et al., 2018). Adhesives are used both to create the joint, as well as reduce galvanic corrosion seen where dissimilar materials are in physical contact (Fays, 2003). Superwood is desirable in structural applications as it is created from wood, which is a renewable resource. The trees used to create superwood take in CO₂ and provide fresh oxygen making them desirable when structural manufacturers are looking to reduce their carbon footprint and work towards a green future. The trees can only grow so large so joining techniques are needed to join superwood to itself and other materials. The use of these joints in application has led to rigorous testing methods for adhesive joining, notably as used here, lap-shear testing (Hu et al., 2013).

FIG. 7 is a schematic showing the proposed bonding mechanisms between aluminum and the superwood in this investigation. The methacrylate adhesive was selected because the MMA polymer bonds to the aluminum and its surface oxides through hydrogen bonding and the carboxylate ionic bonding (Pletincx et al., 2017). It also adheres to the cellulose and lignin in the superwood substrate by hydrogen/chemical bonding and through penetrating the pores to crease a mechanical interlock (Gardner and Tajvidi, 2016). The joining process development and failure mechanism discussions in this investigation are based in bonding mechanisms depicted in FIG. 7.

### Experimental Procedures

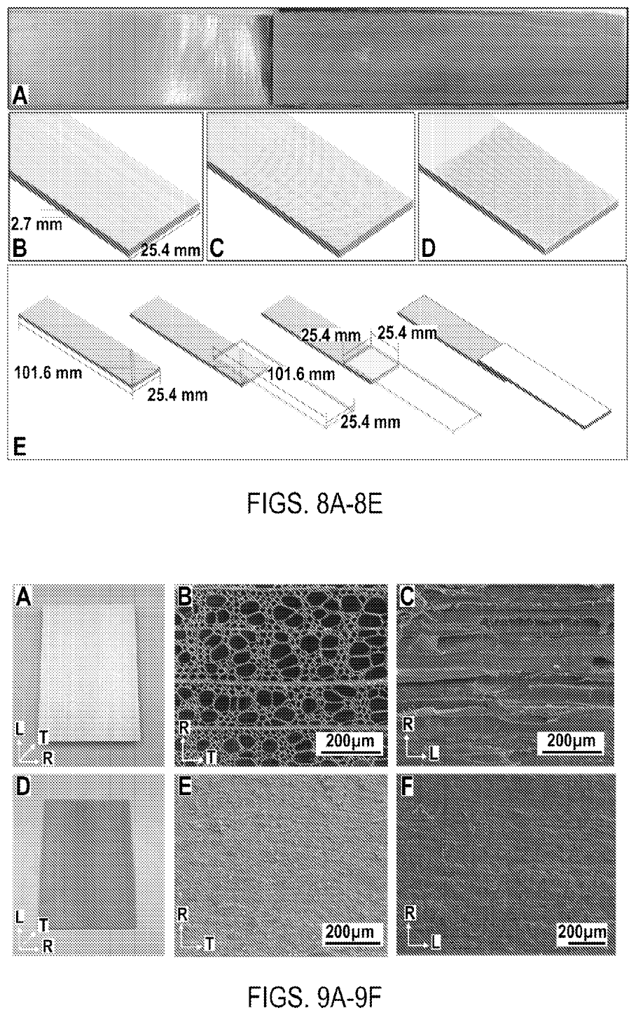

Superwood was prepared by a two-step process described by Song et al. (Nature, 2018). This material was cut into 25.4 mm wide by 101.6 mm long strips, with the width being measured in the direction transverse to the fiber direction and the length being measured along the fiber direction. These samples were on average 2.7 mm thick before any surface preparation, with ranges from 2.5-2.9 mm due to the slight differences between batches. Samples of the same width and length were cut from 2 mm thick A15754 with a nominal composition of Al-3.1 Mg-0.4Mn (all in weight percentage). This alloy was chosen due to its common use in the automotive industry. The joint sample dimensions, as shown in FIG. 8A-FIG. 8E, followed ASTM D1002 and D5868, the standards for single lap shear testing of metal and fiber reinforced plastic respectively. The adhesive used in the first set of samples was Plexus MA832, a methacrylate adhesive designed to adhere to metal without primers. The adhesive was chosen due to its application in the automotive industry specifically with non-metal substrates such as fiber reinforced polymer composites. Its ability to bond well with non-metal substrates suggested it would likely bond better with superwood than adhesives designed only for joining metals. The methacrylate also had the benefit of being time cured rather than heat cured, as studies in natural wood have shown that density and mechanical properties change in wood after heat treatment which could negatively affect the joint (Gong et al., 2010).

### Adhesive Sample Preparation

All samples had adhesive applied in an x-pattern to the aluminum in the 25.4 mm overlap area to guarantee the even spread of the adhesive across the entire bonding area as seen in FIG. 8E. Glass bead spacers of 254-micron diameter were added to the adhesive to ensure a consistent layer height. The superwood was placed over the adhesive and pressure was applied to spread the adhesive across the area, with adhesive overflow being removed before the samples were left to cure at room temperature for 24 hours.

Several surface preparations and clamping forces were used when testing samples to determine the maximum load that could be applied to the joint before failure and to achieve desired failure mechanisms. Surface preparations included no surface preparation (designated as NS) to create a baseline value for the adhesive on raw material, shown in FIG. 8B, sanding of both aluminum and superwood with 320 grit sandpaper with scratches oriented in the same direction transverse to the fiber direction (designated as OS) seen in FIG. 8C, and sanding with the scratches randomly oriented (designated as RS), shown in FIG. 8D. The samples also underwent 3 different pressing forces during curing: 0 N, 667 N, and 1334 N. These forces were applied using one-handed bar clamps through the entire curing process, using the maximum force of the clamp. The only force applied to the 0 N samples was the force of manually holding the top and bottom sheet together when assembling samples. In addition, tests were done using a vice and hammer to create indentations on the material surface. One sample set was made using the indentations solely on the aluminum sheet, and one set was made using the indentations on both the aluminum and the superwood. These allowed for testing of a different pattern of surface roughness than scratches.

### Testing Procedures

The single lap shear specimens were tested in tension using an MTS Criterion Model 43 with a crosshead speed of 2 mm/min. This lies between the speeds dictated by the two ASTM standards for lap shear referenced, with D1002 using a speed of 1.3 mm/min and D5868 using a speed of 13 mm/min. Offsets were used in the grips to center the joint in the machine and avoid out of plane stresses. To mitigate the eccentric loading seen in single lap shear due to the offsets, double lap shear specimens were made matching the RS1334 sample preparation to show comparable results between the two tests. Joint strength was measured by dividing the average load of failure by the adhesive area of the joint, 645.16 mm². All samples used the same adhesive area.

The microstructure of the superwood and natural wood were characterized by using a Hitachi SU-70 Schottky field-emission gun scanning electron microscope (SEM) (2-5 kV). The SEM samples are processed by gold sputtering before the test. Natural wood contains many lumina (tubular channels 20-80 μm in diameter) along the wood growth direction (FIG. 9A-9C). By partial removal of lignin/hemicellulose from the wood cell walls, followed by hot-pressing, the wood lumina as well as the porous wood cell walls collapse entirely, resulting in a densified piece of about 3 times the density of natural wood (FIG. 9D). The super wood has a unique microstructure: the fully collapsed wood cell walls are tightly intertwined along their cross-section (FIG. 9E) and densely packed along their length direction (FIG. 9F).

### Results

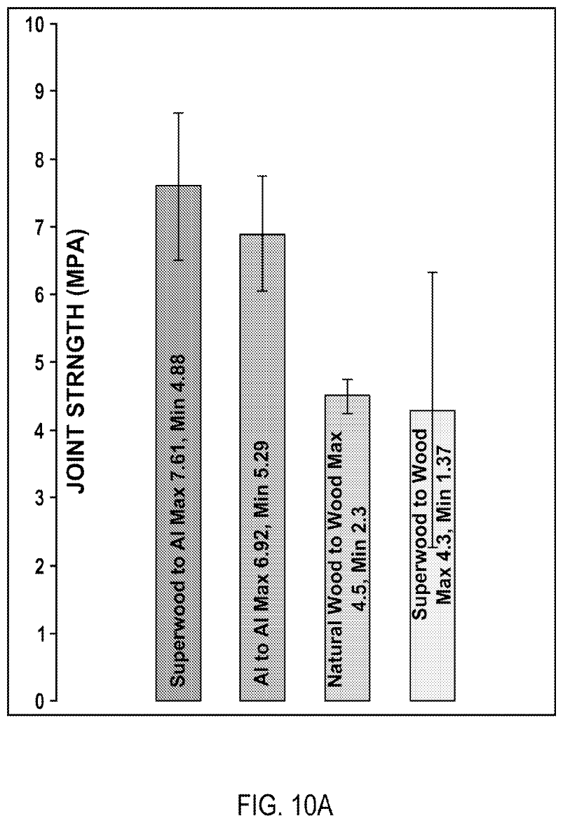

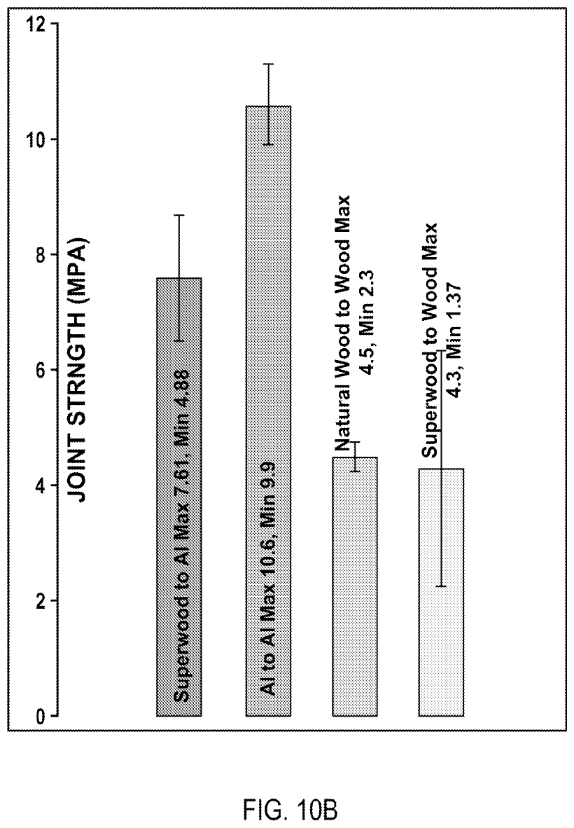

FIG. 10A and FIG. 10B shows the maximum joint strength of aluminum-to-superwood (7.6 MPa) achieved in this investigation, in comparison with the maximum strengths reported in literature for aluminum-to-aluminum and natural wood-to-wood joints and to tests done on superwood-to-superwood bonding of samples using the same adhesive as the superwood-to-aluminum. The adhesive joint strength of natural wood was between 2 and 5 MPa depending on surface roughness, with surface roughness of 1.2 to 1.7 μm producing the best results (Budhe et al., 2015). These tests were done using single strap testing, with a larger bonding area of 2425 mm², compared to the single lap shear 645.16 mm². An epoxy resin was used in these samples with similar shear strength (16.6 MPa when sing aluminum as substrate as per manufacturer data sheets) to the MMA adhesive used in superwood bonding (13.8-19.3 MPa as per manufacturer data sheets). In aluminum bonding with poly methyl methacrylate (PMMA) adhesive, Plexus MA300, Machowiak et al. (2019) saw that with the stronger methacrylate adhesive (20.7-26.2 MPa shear strength as per manufacturer data sheet), and there was a butt-joint yield stress of 21.2 MPa. Using the Tresca uniaxial shear failure theory, this joint can be approximated to have a 10.6 MPa shear stress. In aluminum bonding with poly methyl methacrylate (PMMA) adhesive, Mazur (2017) found that aluminum samples with methacrylate would fail at 5.29 to 6.92 MPa. The superwood-to-superwood joint showed failure at 4.3 MPa due to poor penetration of adhesive into the superwood materials due to reduced pores (collapsed cells as shown in FIG. 9E) in the microstructure. The aluminum-to-superwood joints in this study provide significantly higher (about 50%) strength (7.61±1.1) than natural wood-to-wood (4.50±0.25) and superwood-to-superwood (4.26±2.0) joints and comparable strength (or slightly higher than) of aluminum-to-aluminum joints (6.92±0.85 or 10.9±0.7) given the increase in adhesive strength in the aluminum-to-aluminum literature.

Failure surfaces in wood, both natural and superwood samples, can be difficult to characterize as failures in the adhesive versus failures in the wood. ASTM D5266-99 defines shallow and deep wood failure and provides methods for estimating the percentage of wood failure in adhesively bonded wood joints. Shallow wood failure occurs in the top 1-2 layers of cells beneath the adhesive layer, and the fracture path is unaffected by the grain structure within the wood. This type of failure is undesirable in lap shear joints, as this leads to failure at low loads.

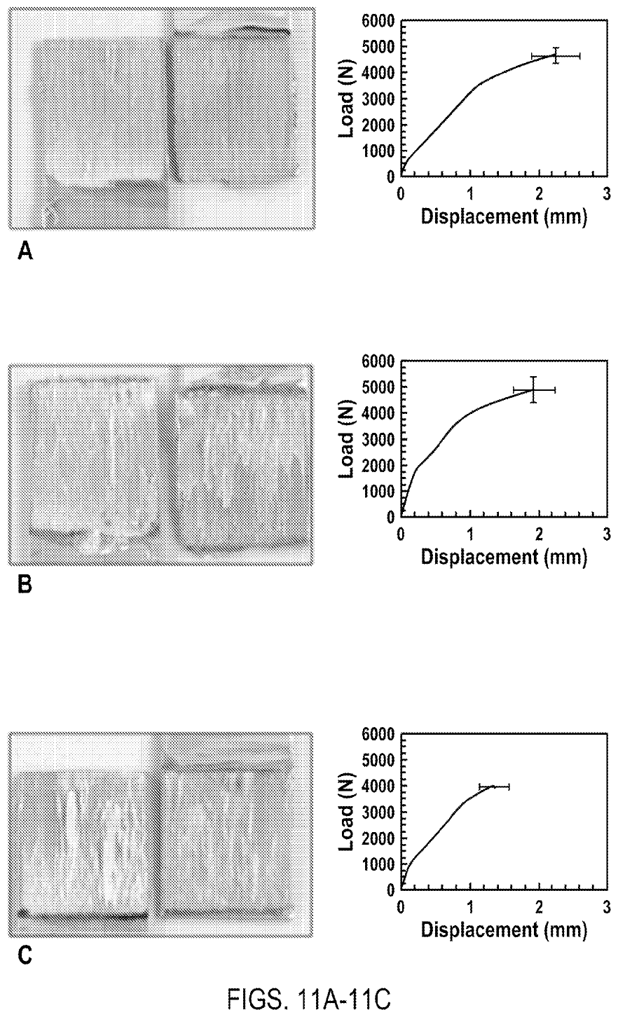

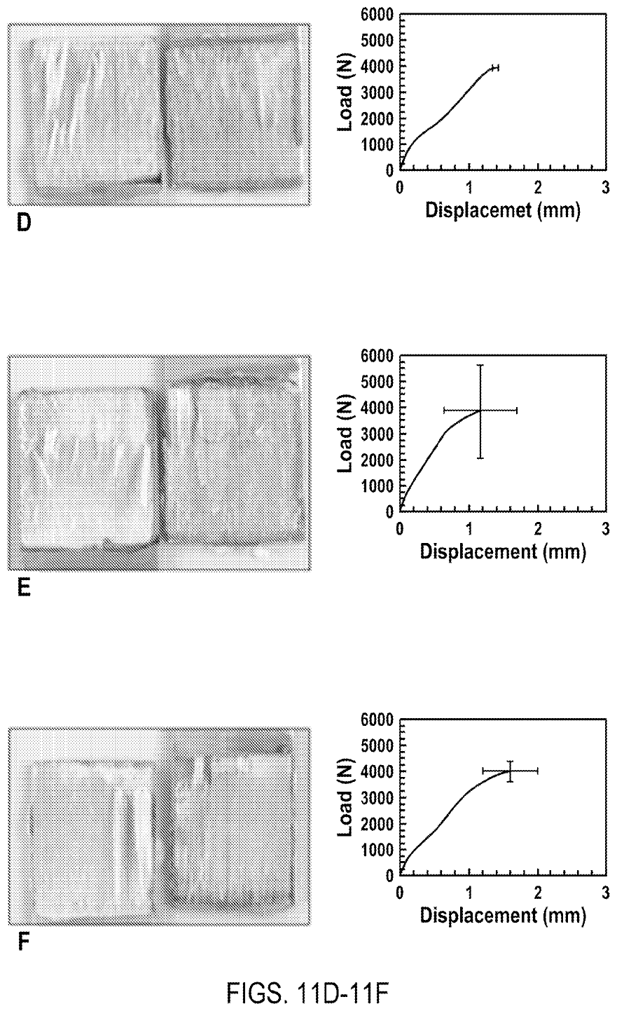

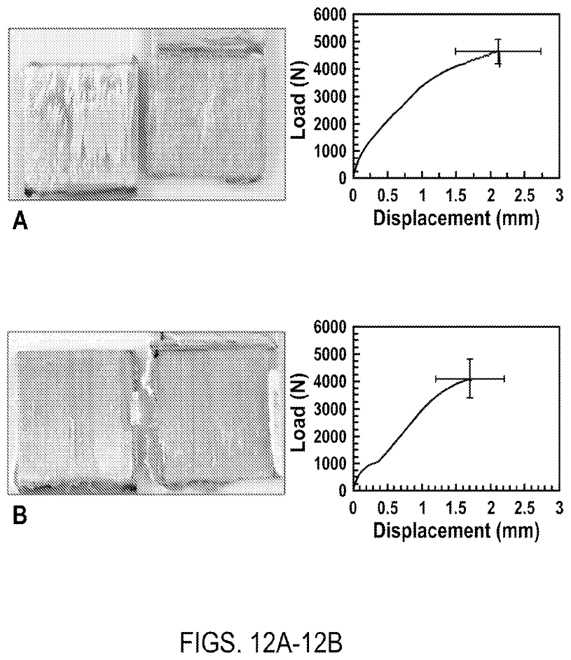

FIGS. 11A-11B shows the joint strength and failure surfaces of aluminum-to-superwood samples prepared in different conditions, with a failure load ranging from 3.86 to 5 kN. Initial testing of joining superwood to aluminum with no surface preparation and no pressure applied during curing showed shallow failure, with a load and displacement of 4707 N and 2.24 mm respectively shown in FIG. 11A. Adding pressure to the untreated superwood during curing using one-handed bar clamps created minimal improvement in the failure depth with the 1334 N force sample fracturing a cell deeper, with a load of 4861 N and a displacement at failure of 1.93 mm, FIG. 11B.

Polishing the superwood surface to have oriented scratches transverse to the fiber direction caused the superwood to have a less uniform failure surface. Portions of the failure surface show that the scratches open the cells and allow adhesive to penetrate deeper and create deeper failure, but portions of the failure surface are shallow failure as seen in the untreated superwood. FIGS. 11C and 11D and 11E show samples with scratches oriented against the fiber direction, where FIG. 11C was with no clamping force, 3989 N and 1.35 mm, FIG. 11D was 667 N of force, 3954 N and 1.39 mm at failure, and FIG. 11E was made with 1334 N of clamping force, with a failure of 3860 N and 1.17 mm. Oriented polishing showed little change in failure loads and elongations regardless of the clamping force during curing.

FIG. 11F shows the randomly oriented polishing with no clamping force. These samples show a failure at 4059 N and 1.60 mm, closer to the samples with no surface treatment than those with oriented polishing.

The samples with randomly oriented scratches that experienced no pressure during curing show similar fracture patterns to the oriented scratches samples with 667 N applied pressure. This may imply that the randomized scratches allow for further penetration into the superwood of the adhesive similar to what a low applied pressure does.

Deep wood failure as per the ASTM standard occurs further in the wood than shallow wood failure and exhibits fracture paths strongly influenced by the grain angle and growth rings of the wood. Large portions of deep failure are seen beginning with the randomly oriented scratches samples that underwent 667 N pressure during curing. These samples showed thicker sections of the superwood surface torn during failure, as well as some gentle curving of the failure surface edges along the grain boundaries. This implies a failure following the grain boundaries as is characteristic of deep wood failure. The grains in the transverse direction are aligned with the fiber growth, making failure in the transverse direction difficult to characterize as following the grains rather than failing in a manner unaffected by grain structure as in shallow failure, so in transverse failure depth is the best way to characterize the deep failure. These samples failed at 4640 N of load and 2.11 mm of extension, outperforming all samples but the samples with no surface treatment and no pressure.

The 1334 N random orientation samples show the deepest failure out of the tested pressure and surface preparation combinations and the clearest indications of influence from the grain in the fracture surface. The sample shown has some slight color variation between the grains near the center of the fracture surface, and the failure is deep enough that that same color variation can be clearly seen in the superwood that remains attached to the adhesive on the aluminum substrate. These samples fail at 4906 N and 2.06 mm of extension on average, the highest force and third highest extension.

Double lap shear samples were tested to determine any effects the eccentric loading present in single-lap shear had on the failure load and displacement. The samples were made with randomly oriented scratches and 1334 N of clamping force with 2 pieces of the 101.6×25.4×2 mm Al 5754 being adhered between two pieces of 50.8×25.4×2.7 mm superwood. The samples had the same total adhesive area as the single lap shear samples, allowing for direct comparison of the two tests. The failure surface continued to show deep wood failure as was seen in the single lap shear samples, but the double lap shear had more consistency in failure load and extension than the single lap shear. This is due to the removal of the eccentric loads. These samples had significantly less variation in the maximum load and extension of the joints than single lap shear, as well as having a defined elastic region. This more clearly shows the change in the slow of the load-displacement curve as the fibers of the superwood begin to separate from the bulk of the material under the shear load.

To further test how altering the substrate surface can affect the failure of the joint, superwood and aluminum were patterned using a vice and hammer to create patterned dents (FIG. 14A-FIG. 14C). The dents proved to excessively damage the superwood, becoming crack initiators, so instead the aluminum was patterned while the superwood was more roughly polished with 80 grit sandpaper. Glass bead spacers were not used in these tests.

These proved to greatly increase the adhesion of the joint. The joint failed in the superwood, leaving several even layers of superwood fibers on the adhesive after failure thick enough to completely obscure view of the adhesive. The roughly polished superwood surface may help the adhesive penetrate into the deeper layers of the superwood, since the 80 grit sandpaper may introduce deeper scratch than the 320 grit sandpaper. More superwood layers adhere to the adhesive leading to several layers of superwood peeling off from the bulk of the superwood sample. It also shows significant improvement in the failure load and extension at failure, with the load increasing from 4910 to 6775 N and extension increasing from 2.06 to 4.49 mm. These samples had significantly less variation in the maximum load and extension of the joints than single lap shear, as well as having a defined elastic region. This more clearly shows the change in the slow of the load-displacement curve as the fibers of the superwood begin to separate from the bulk of the material under the shear load.

### Fracture Analysis

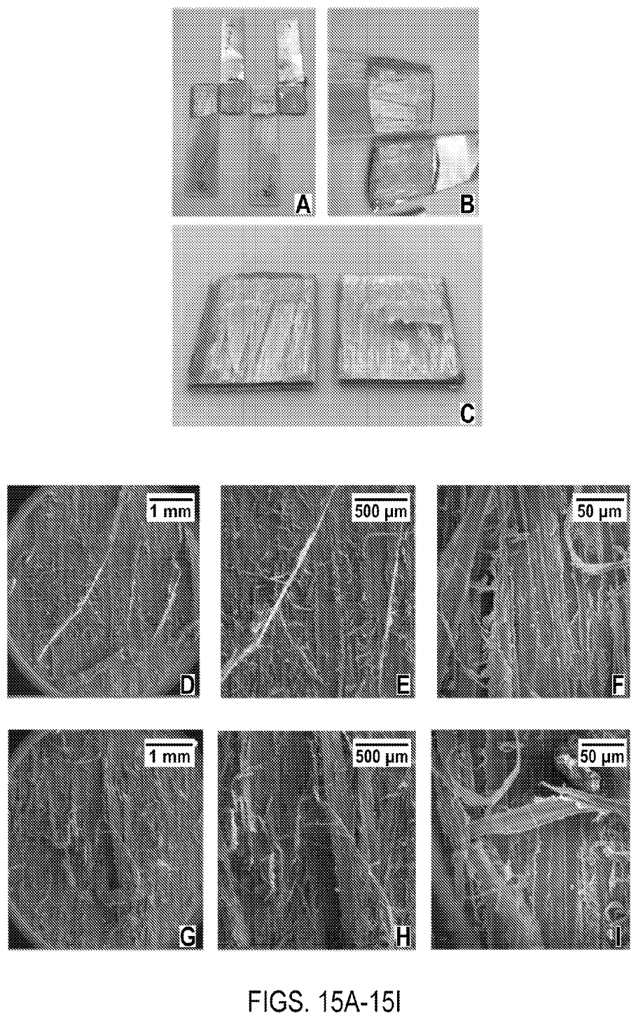

Samples were studied under SEM to determine if there was information on the failure mechanism and adhesion that could be determined at that scale. Samples from the RS1334 group were tested, and imaging showed, in significantly more detail, the damage to the superwood fibers at failure (FIG. 15A-FIG. 151). Fibers that were attached to the adhesive were torn away from the bulk of the superwood as the sample was put under tension until the force was too strong and fibers broke. Many of the individual fibers at the surface show breakage, though some remain in larger fiber bundles even after failure, retaining their structure despite the damage.

### DISCUSSION

Among the average joint test curves, the 667 N clamping shows stronger results than the 0 and 1334 N samples of each preparation, with both higher elongation and failure load at failure as seen in FIG. 11. However, the 1334 N samples perform the best at the maximum load for an individual sample. This may imply that the best force to apply during curing is somewhere in between the two values. The 1334 N samples do have some low values that may be caused by more adhesive being forced out of the bond area than is truly in excess of the adhesive needed for bonding during the clamping. The 0 N samples tend to perform poorly in regards to depth of failure, showing scarce fiber covering of the adhesive surface and areas of adhesive with no wood visible of its surface, as some pressure is needed to force adhesive into the pores of the superwood. The samples with no surface preparation show the shallowest failure of all samples, with the superwood failing at the wood-adhesive interface. The samples show a fine layer of superwood fibers remaining on the adhesive at failure, while all other samples show some areas where the adhesive penetrated more deeply than the first layer of cells and the superwood fibers stay together. The oriented samples showed a lower strength than those without surface treatment. In the no surface treatment samples, there is some surface roughness due to the process of making the superwood, which creates a shallow but random surface roughness. There is also a deeper roughness from the wood structure itself, with the fibers creating an uneven surface. The oriented scratches remove this random roughness in the surface, replacing it with shallow grooves oriented in one direction. This removes any surface damage that aided in adhesion, while not increasing surface roughness enough to have a strong effect, as well as risking burnishing that can smooth the surface.

The samples with no surface treatment and lower force show high failure loads as the adhesive has a clean surface to adhere to, with no stray fibers acting as debris in the joint. However, these samples show poor failure mode, as described above, as the lack of surface preparation prevents deeper penetration into the superwood. The no surface treatment samples made at the highest force performed worse than the samples made at lower loads, as though there was a slight increase in failure load, there was a significant drop in extension at failure, as without surface treatment to open the pores the force spread the adhesive across the sample and out of the joint rather than pressing it into the open pores. The RS1334 did not have this issue as the randomly oriented scratches opened pores for the adhesive to flow into and the force ensured the adhesive flowed deeper into the superwood. The randomly oriented scratches can however cause a burnishing effect, lowering the wettability and adhesion of the joint. This is due to the wood fibers that have been torn being pushed together as the sanding process continues, creating a smooth surface rather than a rough one.

Using a vice and hammer creates a rough surface without smearing the wood fiber in a way that can cause burnishing, though the rough points are more distinct and can become stress concentrators. The largest drawback to using a vice and hammer is that using excessive force on the vice can cause indentations to cause cracks rather than create roughness to improve adhesion, which cannot happen using sandpaper. Using a combination of methods can prove best. Using rougher sandpaper on the superwood can help the adhesive penetrate into the deeper layers of the superwood, since the 80-grit sandpaper may introduce deeper scratches than the 320 grit sandpaper, while using a vice and hammer on the aluminum creates a rougher surface than just using sandpaper. Using this method shows great improvement of both maximum load and maximum extension over just using sandpaper on the substrates.

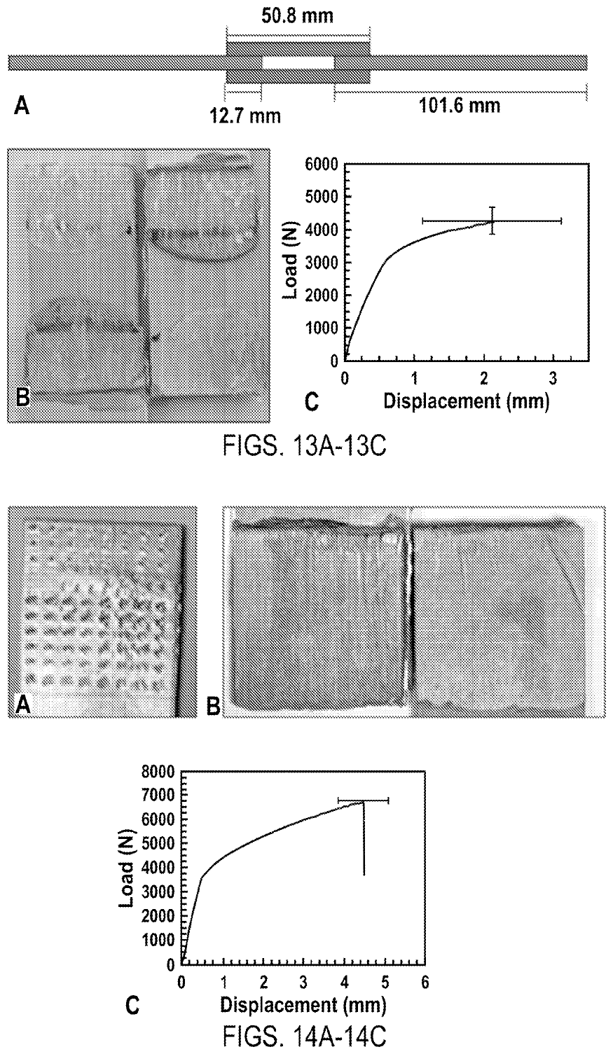

The double lap shear samples show results similar to the single lap shear samples with the same preparations, the results fall into the same range of final loads and displacements. However, the double lap shear shows the stiffness and work to failure more visibly shown in FIG. 13, and when converted to stress-strain, shows much more clearly the elastic region. Using the double lap shear avoids the risk of eccentric loadings distorting the results, as well as avoiding the need for offsets in the testing apparatus that could result in slip during the test, at the expense of being more complex to produce the samples and using more material.

When determining the best method for creating a strong joint, the first priority is usually to create a joint with a large maximum load at failure. The joint failing due to the parent material is often the best indicator of a strong joint. However, the elongation at failure is also important, especially for applications subjected to crash loading. A joint with a high elongation has more energy absorption before failure than one with the same failure load but a lower elongation.

### Bonding Mechanisms

Wood is a naturally porous material, with channels throughout the structure that carried water and nutrients throughout the tree when it was living. The superwood densification process collapses most of these, but the ability of the adhesive to penetrate the surface and create bonds within the superwood still affects the adhesive bonding process. To form a good bond, the adhesive has to penetrate at least 2-6 cells deep to create a mechanical interlock. The densification makes this more difficult. Natural wood joints strengthen with density, but denser woods make it more difficult to create these strong bonds as there are fewer pathways for the adhesive to penetrate the wood. The way to assist in this is increasing the surface wettability and using pressure during the curing process. The surface damage created during the polishing process can create a larger surface area for the adhesive to apply to, and it also increases the wettability of the surface. The wettability test for natural wood and treated wood such as superwood generally follows that if a piece of wood can have a drop of water spread out and absorb into the wood in 20 seconds, then that wood will easily form adhesive joints. If it spreads but does not absorb within 40 seconds, it has good wettability, but not good penetration (Vick, 1999). Using the wettability test, it was shown that the superwood with no surface treatment had poor wettability, with the samples with random scratches along the surface had good wettability without good penetration when testing using water. The preparation serves to both increase the wettability to aid in adhesive flow across the surface and to open up pores so the pressure applied can help mitigate the poor penetration.

Using pressure during the adhesive process both spreads the adhesive across the surface and forces the adhesive into the pores that remain open. It can also force the adhesive into areas where loose fibers at the superwood surface have created air pockets, displacing the air and filling the area with adhesive. For dense woods, it is recommended in traditional wood joinery to use a force of at least 1.7 MPa, which falls between the two loads used for the superwood samples. This creates the mechanical interlocking through the cells as seen in FIG. 7, while allowing for more contact area between the MMA and cellulose fibers to create hydrogen/chemical bonds.

The issues seen in the patterned superwood could be due to the fracturing it creates within the superwood. Large damage to the surface breaks the superwood and creates weak spots within the bulk around where damage occurred. These weaknesses then become a point of failure. The dents created during patterning become crack initiators which outstrips their usefulness in allowing the adhesive to penetrate deeper into the superwood. The samples where only the aluminum is patterned while the superwood is scratched gives the best of both methods. Patterning the aluminum slightly increases the surface area for the adhesive bonding without noticeably affecting the aluminum as it is ductile enough to undergo the patterning without cracking, while the scratches on the superwood allow for adhesive penetration into the wood without creating failure points.

Additionally, hydrogen bonds play important roles in chemical joint's behavior in wood materials. These bonds form between the functional groups of the adhesive and the hydroxyl groups in the wood cellulose structure (Gardner and Tajvidi, 2016). For aluminum alloys, all surfaces are covered by a natural thin layer (typically a few nanometers) of oxide Al₂O₃(Zhu et al., 2017). The PMMA adhesive has already been proved to adhere to aluminum oxide (on the surface of aluminum samples) through hydrogen bonds and carboxylate ionic bonding, so the adhesive is known to be suitable for hydrogen bonding adhesion (Pletincx et al., 2017). When the methacrylate polymer reaches the oxide surface of the aluminum, a surface hydroxyl group hydrolyzes the ester bond in the side chain of the polymer backbone. As a result of this reaction, a carboxylate anion is formed which bonds ionically with an aluminum cation of the surface (Konstadinidis et al., 1992). Thus, as shown in FIG. 7, hydrogen/chemical bonding between the Al₂O₃ film on the aluminum surface and MMA adhesive and the cellulose structure in superwood provides the foundational bonds in aluminum-to-superwood joints, in addition to the mechanical interlocks due to adhesive penetration in surface pores/patterns in both superwood and aluminum samples.

It should be pointed out that no direct evidence of chemical bonds has been found between PMMA and superwood, which is a subject of ongoing research. However, chemical bonds likely play a more dominant role hydrogen bonds in PMMA/superwood interface, since the shear strength of the joint samples is similar to that of superwood. The superwood material was damaged after the test rather the adhesive itself or adhesive/aluminum interface. This result suggests that the strength of the PMMA adhesive or adhesive/superwood interfacial strength is higher than the chemical bonds between cellulose molecules.

### SUMMARY

Adhesive bonding has been proven an effective joining method for superwood to aluminum alloys in this investigation. The selection of a methacrylate-based adhesive and proper application (no surface preparation and low force or random orientation polishing and high force) provide high strength (7.5 MPa) for aluminum-to-superwood joints, which significantly higher (about 50%) than wood-to-wood joints and comparable to aluminum-to-aluminum joints. These results can be improved by patterning the aluminum using a vice and hammer while polishing the superwood with 80 grit sandpaper to create a rougher surface.

The methacrylate-based adhesive bonds to the aluminum (via aluminum oxide film) and superwood through hydrogen bonds. Chemical bonding mechanisms are also likely involved, such as the ionic bonding between aluminum oxide and PMMA, but have not yet been proven between PMMA and superwood. Patterning the aluminum surface allows for more contact area between the adhesive and the aluminum, creating more chances for bonds to form. Surface preparation of the superwood has the same effect on the hydrogen/chemical bonds between cellulose and MMA, while also opening pores in the wood for adhesive to flow into and create a mechanical interlock. Between these, the adhesive is able to bond strongly with both substrates, creating failure in the wood material, whether shallow or deep failure, rather than failure within the adhesive itself.

### REFERENCES

Ayrilmis, N., Candan, Z., Akbulut, T., Balkiz O., 2010. Effect of Sanding on Surface Properties of Medium Density Fiberboard. DRVNA INDUSTRIJA 61, 175-181.
Barnes, T., Pashby, I., 2000. Joining techniques for aluminium spaceframes used in automobiles. Journal of Materials Processing Technology 99, 62-71.
Budhe, S., Ghumatkar, A., Birajdar, N., Banea, M.D., 2015. Effect of surface roughness using different adherend materials on the adhesive bond strength. Applied Adhesion Science 3:20.
David, E., Lazar, A., 2003. Adhesive bonding between aluminium and polytetrafluoroethylene. Journal of Materials Processing Technology 143-144, 191-194.
Ebnesajjad, S., 2011. Characteristics of Adhesive Materials, in: Handbook of adhesives and surface preparation: technology, applications and manufacturing. William Andrew/Elsevier, Amsterdam.
Fays, S., 2003. Adhesive Bonding Technology in the Automotive Industry. Adhesion and Interface 4, 37-48.
Frihart, C. R., 2005. Adhesive Bonding and Performance Testing of Bonded Wood Products. Journal of ASTM International 2, 12952.
Gardner, D. J., Tajvidi, M., 2016. Hydrogen Bonding in Wood-Based Materials, an Update. Wood and Fiber Science 48, 234-243.
Gong. M., Lamason. C., Li. L., 2010. Interactive effect of surface densification and post-heat-treatment on aspen wood. Journal of Materials Processing Technology 210, 293-296.
Hu, P., Han, X., Li, W. D., Li, L., Shao, Q., 2013. Research on the static strength performance of adhesive single lap joints subjected to extreme temperature environment for automotive industry. International Journal of Adhesion and Adhesives 41, 119-126.
Konstadinidis et al. 1992. Segment Level Chemistry and Chain Configuration in the Reactive Adsorption of Poly (methyl methacrylate) on Aluminum Oxide Surfaces. Langmuir, 1307-1317.
Lüder, S., Härtel, S., Binotsch, C., Awiszus, B., 2014. Influence of the moisture content on flat-clinch connection of wood materials and aluminium. Journal of Materials Processing Technology 214, 2069-2074.
Lunder, O., Olsen, B., Nisancioglu, K., 2002. Pre-treatment of AA6060 aluminium alloy for adhesive bonding. International Journal of Adhesion and Adhesives 22, 143-150.
Mackowiak, P., Placzek, D., and Slotysiak, A. 2019. Mechanical properties of methacrylic plexus MA300 adhesive material determined in tensile test and butt joints of aluminum thick plates. MATEC Web of Conferences 290.
Magoss, E., 2008. General Regularities of Wood Surface Roughness. Acta Silv. Lign. Hung. 4, 81-93.
Mazur, P., 2017. Evaluation of the quality of cyanoacrylate joints using the example of poly (methyl methacrylate) and polycarbonate. Production Engineering Archives 14, 7-10.
Özçifçi, A., Yapici, F., 2008. Effects of machining method and grain orientation on the bonding strength of some wood species. Journal of Materials Processing Technology 202 353-358.
Pan, L., Ding, W., Ma, W., Hu, J., Pang, X., Wang, F., Tao, J., 2018. Galvanic Corrosion Protection and Durability of Polyaniline-Reinforced Epoxy Adhesive for Bond-Riveted Joints in AA5083/Cf/Epoxy Laminates. Materials and Design 160, 1106-1116.
Pereira, A. M., Ferreira, J. M., Antunes, F. V., Bártolo, P. J., 2010. Analysis of manufacturing parameters on the shear strength of aluminium adhesive single-lap joints. Journal of Materials Processing Technology 210, 610-617.
Pletincx, S., Marcoen, K., Trotochaud, L., Fockaert, L. L., Mol, J. M. C., Head, A., Karslioğlu, O., Bluhm, H., Terryn, H., Hauffman, T., 2017. Unravelling the chemical influence of water on PMMA/Aluminum Oxide hybrid interface in situ. Scientific Reports 7:13341.
Plexus Structural Adhesives, 2022, Guide to Bonding: Plastics-Composites-Metals, https://www.curbellplastics.com/Research-Solutions/Technical-Resources/Technical-Resources/Plexus-Adhesives-Guide-to-Bonding.
Rushforth, M., Bowen, P., McAlpin, e E., Zhou, X., Thompson, G., 2004. The effect of surface pretreatment and moisture on the fatigue performance of adhesively-bonded aluminium. Journal of Materials Processing Technology 153-154, 359-365.
Selbo, M. L. 1975. Adhesive bonding of wood, in: U.S. Dep. Agr., Tech. Bull. No. 1512, pp. 124.
Song, J., Chen, C., Zhu, S., Zhu, M., Dai, J., Ray, U., Li, Y., Kuang, Y., Li, Y., Quispe, N., Yao, Y., Gong, A., Leiste, U. H., Bruck, H. A., Zhu, J. Y., Vellore, A., Li, H., Minus, M. L., Jia, Z., Martini, A., Li, T., Hu, L., 2018. Processing bulk natural wood into a high-performance structural material. Nature 554, 224-228.
Vick. C. B., 1999. Adhesive Bonding of Wood Materials, in: Wood Handbook-Wood as an Engineering Material, U.S. Dept. of Agriculture, Forest Service, Forest Products Laboratory, Madison, WI.
Vitosytė, J., Ukvalberginė, K., Keturakis, G., 2012. The Effects of Surface Roughness on Adhesion Strength of Coated Ash (Fraxinus excelsior L.) and Birch (Betula L.) Wood. Materials Science 18.
Vitosytė, J., Ukvalberginė, K. Keturakis, G., 2015. Wood surface roughness: an impact of wood species, grain direction and grit size. Materials Science 21.
Xie Y et al. 2020. Friction stir spot welding of aluminum and wood with polymer intermediate layers. Construction and Buliding Materials 240.
Yin W et al. Tribological properties of the rotary friction welding of Wood. Tribology International 167.
Zhu, Z., Chen, Y., Luo, A. A., Liu, L., 2017. First conductive atomic force microscopy investigation on the oxide-film removal mechanism by chloride fluxes in aluminum brazing. Scripta Materialia, 138, 12-16.

### Example 2-Dissimilar Material Joining of Superwood to Aluminum by Self-Pierce Riveting and Rivbonding

Superwood is a high-performance, lightweight material composed of densified wood that has been partially delignified through chemical treatment to create a stronger material than natural wood [1]. To fully utilize the properties of this material, it must be able to join to other materials when used in application. Without joints, the material can perform excellently in a lab while being unused by industry.

To join dissimilar materials, one can either use chemical joints or mechanical ones. Chemical joints include all forms of adhesive, which form a bond along the entire contact surface rather than at intervals as is the case of mechanical joints [2]. Mechanical joints include fasteners such as nails, rivets, and screws, as well as interlocking mechanisms such as dovetail joints. These two forms of joining can be used separately or be combined to create a joint using the strengths of both methods.

Self-pierce riveting differs from traditional riveting by removing the need to pre-drill holes for the rivet to pass through. Instead, the rivet is pressed through a stack of material and flares in the bottom sheet of the stack, with a die providing shape to the joint [3]. The rivet comprises a hollow cylindrical body capped on one end by the head of the rivet. The head can be in a variety of shapes, affecting the stress concentrations around the rivet during insertion [4]. The profile of the leg, as a cross-section of the rivet body is typically called, affects the sheet piercing, flaring, and contact between sheets in the stack [5]. The rivet is typically coated to prevent corrosion, and the coating type can affect the joint strength due to surface roughness differences affecting the friction resistance between the rivet and the stack [6]. A rivet with low friction coefficient will have an easier penetration into the top sheet and flaring, but high friction coatings lead to higher strength [7]. The die geometry, such as the die radius, presence of a pip, a conical section in the center of the die, and shape of the die groove all affect the stresses in the bottom sheet and plastic flow of the material [8]. The effective length of the rivet in the bottom sheet, defined as the distance between the upper surface of the bottom sheet and the bottom of the rivet, is determined by die depth. This length affects the joint strength as a longer effective length allows for a stronger bond within the material [9].

The self-pierce riveting process can be broken into 4 steps, as defined in work by Haque et. al. [10]. As the rivet comes into contact with the top sheet, stage 1 begins with the stack bending and the die being partially filled by the bottom sheet. Stage 2 begins when the rivet pierces the top sheet when the force of insertion meets the ultimate strength of the sheet. The insertion causes the bottom sheet to continue bending and begin to touch the die surface. A gap between top and bottom sheets can be seen in this stage due to the difference in bending between sheets. The third stage removes this gap as the rivet passes through it and begins to pierce the bottom sheet once the die is completely filled. At this point, the material has no more area to fill, so the force of insertion deforms the rivet, creating either a flare in the rivet or a bulge. The flare is needed to create a good interlock between the rivet and the stack, but the rivet can bulge if the rivet is too long for the stack height or the sheet is too hard compared to the rivet. Creation of a flare begins stage 4. This stage is also characterized by the thinning of the bottom sheet by compressing the material in the die and inside of the rivet cavity. Each of these stages are affected by every part of the stack, from material choice and thickness, to rivet and die geometry.

The material properties of the top and bottom sheet greatly affect the properties of the joint. The joint strength is most affected by the top sheet, while the shock resistance is primarily determined by the bottom sheet [11]. When joining two dissimilar materials with similar strength, the failure occurs in either sheet, but when the strength differs, joints will fail in the weaker material [12]. The bottom sheet also determines the fatigue endurance of a joint, and a harder upper sheet can lead to the top sheet causing crack initiation on the bottom sheet during testing [13].

An important factor in analyzing the quality of riveted joints are the defects possible within a joint. These include bulging of the rivet which causes the rivet to fail to form a mechanical interlock [10]. Others are penetration through the bottom sheet, where a joint fails due to the rivet piercing through the bottom sheet instead of flaring within it, necking in the lower sheet, where the bottom sheet thins excessively causing weak spots around the rivet button, and sheet separation, where the rivet fails to flare properly and the sheets are separated with little force [14]. The ratio of top sheet thickness to bottom sheet thickness can pose issues such as rivet entrapment. This refers to the top sheet bending severely around the rivet reducing the insertion depth, or the distance between the rivet tip and the upper surface of the bottom sheet [15].

In addition to SPR, rivbonding is a common process in which joints are adhesively joined before the rivet is inserted. This allows the joint the strength of both bonding types. The adhesive allows for a higher maximum load and stiffness under tensile conditions, while the rivet greatly increases the energy absorption of the joint [16]. There is a slight decrease in maximum load compared to purely adhesive joints due to the reduction in adhesive area caused by the rivet [17].

Self-pierce riveting and rivbonding has seen research in recent years focused on its use with fiber-reinforced polymers, commonly used in vehicle lightweighting due to their high strength despite being a fraction of the weight of common structural metals [18]. The study of SPR with CFRP has shown that the rules of proper joining between metallic substrates may be slightly difference when applied to fiber-reinforced polymer. Rao et. Al showed that a rivet head that is higher than the top sheet rather than flush increases the failure load of the joint [19]. Raised rivet head height also increases fatigue life, though it has little effect on tensile load or fatigue in cross-tension samples [20]. The failure of CFRP riveted joints tend to occur while undergoing tension the rivet crushes and deforms the composite around the rivet creating a larger rivet hole, which the rivet head then pulls through [21]. Rivbonding of CFRP tend to fail in the composite due to the rivet creating a hole in the material leading to stress concentrations at that point [22].

Riveted samples are tested in lap-shear, which requires either offset grips or spacers added into the tensile setup to avoid out of plane stress and bending [23].

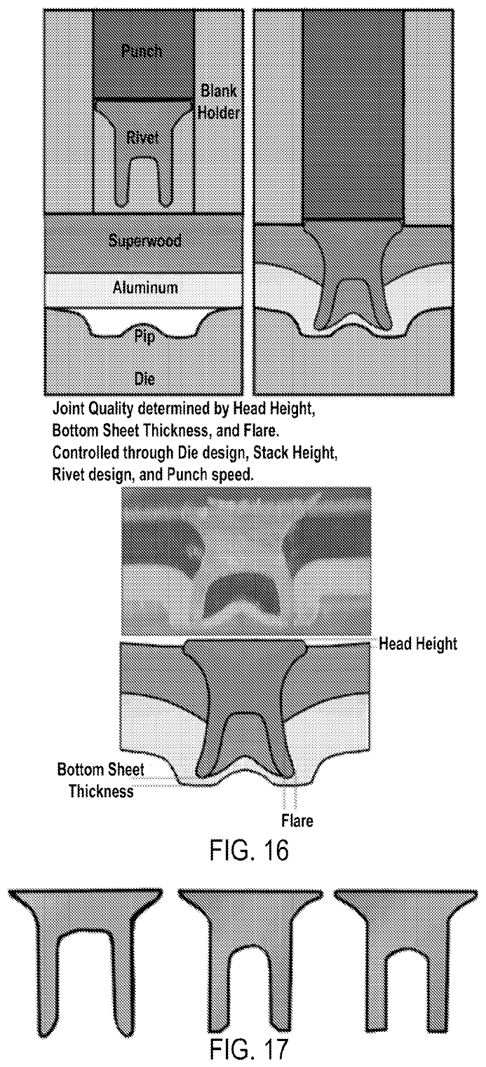

FIG. 16 covers SPR process and cross section elements that determine joint quality

### Experimental Procedures

Material Selection and Preparation. Superwood was prepared by the process described by Song et al. [1]. This material was cut into 25.4 mm wide by 101.6 mm long strips, with the width being measured in the direction transverse to the fiber direction and the length being measured along the fiber direction, with an average thickness of 2.7 mm. Two-millimeter-thick sheet of A15754 with a nominal composition of Al-3.1 Mg-0.4Mn (all in weight percentage) was cut to the same dimensions. This alloy was chosen due to its common use in the automotive industry. The joint sample dimensions followed ASTM D1002 and D5868, the standards for single lap shear testing of metal and fiber reinforced plastic respectively.

The rivets used were sourced from Henrob, a subsidiary of Atlas Copco. The rivets were all of 3 mm diameter and 6 mm length with C-type heads. The length was chosen as appropriate for the 4.7 mm stack height allowing for the rivet head to be flush with the top sheet and flare within the bottom sheet without being too short to properly join to the bottom sheet or so long as to cause the rivet to exit the bottom sheet. The 3 mm diameter was one of two diameters available, the other being 5 mm, and showed more promising results in initial test samples, so research focused there.

Three styles of rivet were tested, J, P, and R style as defined by Henrob (FIG. 17). These styles refer to the rivet shape, particularly the shape of the rivet base. R-style rivets have a flat base, while P and J have a curve between inner and outer edges of the base, which alter the flaring behavior and stresses during rivet insertion. The rivets were all of type 10 boron steel with 480 Hv hardness coated with a zinc-tin coating.

The adhesive used in rivbonded samples was Plexus MA832, a methacrylate adhesive designed to adhere to metal without primers. MA832 was chosen due to its automotive applications involving non-metal substrates. Its ability to bond well with non-metal substrates implied it would likely form a stronger bond with superwood than metal specific adhesives.

Riveting Process—Low Speed Insertion. Samples riveted at low speed were created using the Rivlite. The Rivlite is a battery powered, handheld rivet setter with insertion forces of 20-50 kN. The rivet is set into the nose of the Rivlite either using a tape feed or by manually inserting a single rivet, and force is determined using the dial on the machine. The sample is then held in place flush against the rivet die as the rivet setter presses the rivet into the stack. The process utilizes a sample holder if done by an individual to hold the sample in the correct position to create a single lap shear sample, or can be held in place by hand if the process is performed using two people.

Riveting Process—High Speed Insertion. Samples riveted at high insertion speed were created using the Henrob 33-00045, a servo electric tool rivet setter. The rivets are tape-fed into the machine and insertion speed is set using a digital input, with the insertion force being reported after insertion. As the machine is floor mounted and vertically oriented, samples can be held in proper orientation to create lap-shear joints by a single individual with no need for a sample holder to prevent sheet slipping during rivet insertion.

Rivbond Sample Adhesive Preparation Method. Rivbond samples were adhesively joined before being riveted using the procedures stated above. The top and bottom sheet were cleaned and had the surface roughened using 320 grit sandpaper as had been shown to be an effective bonding method. The samples were then split into two categories: rivbonding before adhesive cure and riveting after adhesive cure. Samples that were riveted before the adhesive cured had adhesive applied to the bonding surface of the bottom sheet, a 25.4×25.4 mm area, had the top sheet applied with manual pressure to force excess adhesive from the joint. The excess adhesive was removed and the rivet was immediately inserted. The samples where the rivet was applied after adhesive curing had the same adhesive application process but were then allowed to cure for 24 hours while 1337 N of force were continuously applied during curing using bar clamps to encourage adhesive penetration into the wood.

Testing Procedures. The single lap shear specimens were tested in tension using an MTS Criterion Model 43 with a crosshead speed of 2 mm/min. The speed was determined by the two ASTM standards for lap shear referenced, with D1002 using a speed of 1.3 mm/min and D5868 using a speed of 13 mm/min. The lap shear speed was kept closer to the speed of the metal standard than the fiber reinforced polymer as the joint is half metal and the superwood making up the other half of the joint is somewhere between the metal and fiber reinforced polymer in behavior. Offsets were used in the grips to center the joint in the testing apparatus and avoid any out of plane stresses caused by joint geometry.

Characterization. Characterization can be split into two categories: joint quality and joint failure. Joint quality refers to the analysis of the joint cross section. A quality rivet joint will have a strong flare within the bottom sheet, will have the head with a certain height above the top sheet, will have a certain amount of material in the thinnest section of the button, and will have no signs of buckling or cracking. The numerical quantification of these features and what values constitute a quality joint change with regards to factors such as stack material and stack height, leaving the determination of joint quality a somewhat subjective field when exploring new materials. Some flaws in riveted joints require no such ambiguity as they are obvious in any material such as buckling or leg bending, where the rivet deforms with the rivet body folding in on itself instead of flaring, frequently a sign of either a top sheet that is too hard for the material or a die with insufficient pip to encourage flaring, depending on whether the failure is above the material or inside the stack.

Joint failure refers to the joint properties after the test, such as whether there was failure of the top or bottom sheet of the stack, whether the rivet head pulled through the top sheet or whether the rivet base pulled out of the bottom sheet. It also includes issues such as button failure, tearing of the bottom sheet material stretched around the rivet base, that was not present before the testing,

### Results

### Joint Strength

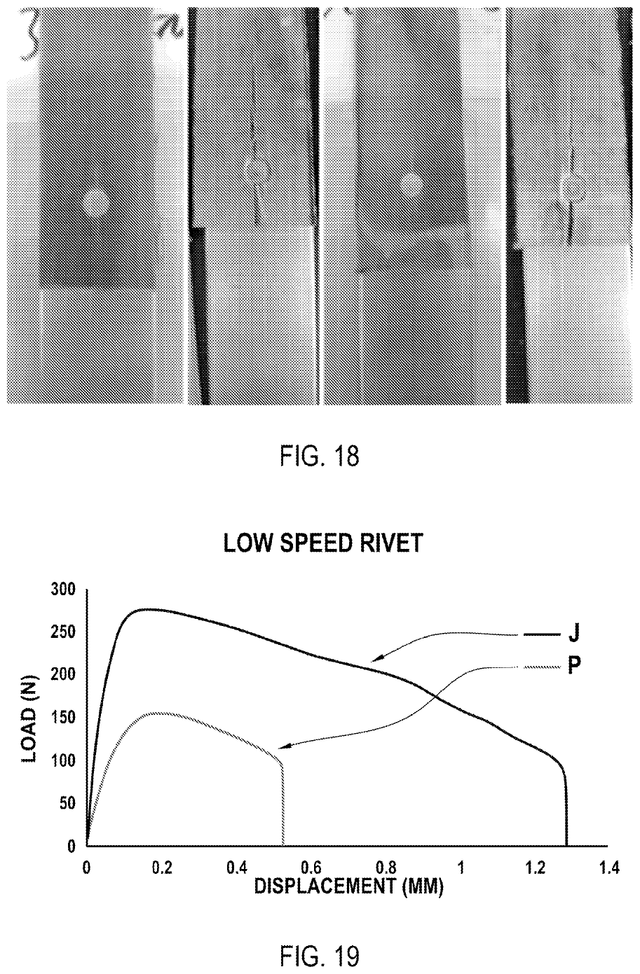

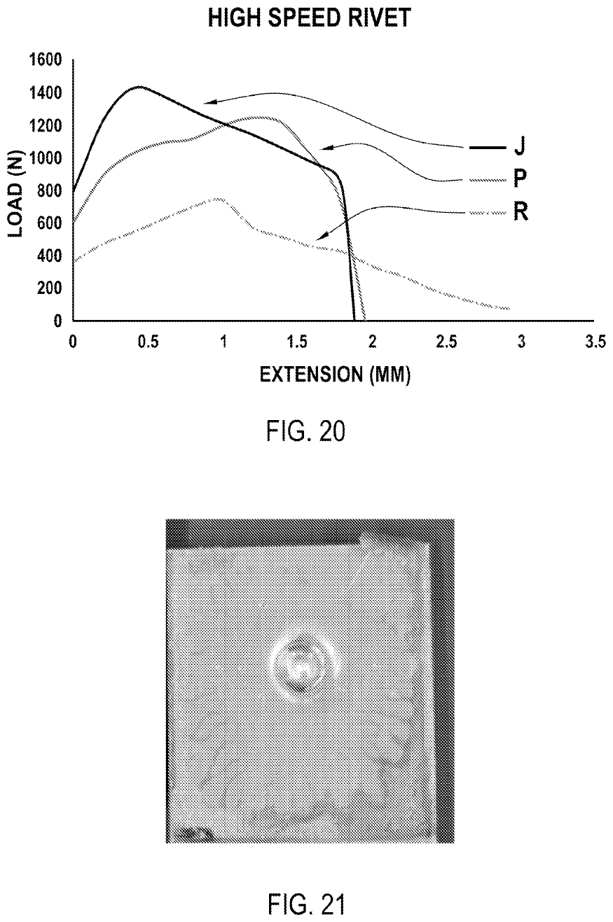

Rivet. Three types of rivet of varying leg geometries were tested at the same insertion speed and die geometry to determine the best rivet style to use in further testing FIG. 18-FIG. 20). The R-style rivet showed a significantly lower load at failure than P or J, as the rivet caused significant cracking of the superwood during insertion. This is due to how blunt the rivet tip is. The cracking occurred in the fiber direction of the superwood, with major cracks at the 12 and 6 o'clock positions around the rivet that span the entire thickness of the sheet and crushing around the rivet head. The J and P-style rivets showed less cracking, with some minor crushing around the rivet head and surface cracks at 12 and 6. J-style rivets had a larger maximum failure load than P-style by 200 N using high insertion seed riveting, but P-style has a slightly longer extension. The J and P-style rivets were also tested in low-speed riveting, with both showing large amounts of cracking. They had cracks at the 12 and 6 o'clock positions that went through the entire thickness of the superwood and reached over 50% the length of the top sheet (50.8 mm). In low speed, the results of the joint strength were inconclusive due to cracking. The damage was a larger contributor to the failure than any other factor, and the tests showed that J and P-style rivets cause similar damage at low-speed insertion.

Rivbond. Generally, when rivbonding the rivet is inserted when the adhesive is still uncured. As the best adhesive practices found for superwood with the Plexus MA832 are specific, both this process and the rivet being inserted after the adhesive is fully cured were tested. When testing samples where the adhesive was applied and the rivet immediately inserted, the fracture surface was found to have very little adhesive. This is due to the force of riveting pressing the adhesive out of the joint. Consequently, these joints showed little improvement over riveting with no adhesive. The samples that were allowed to fully cure showed the expected results of a maximum failure low slightly lower than pure adhesive but with much larger extension and energy absorption. These samples were all made with J-style rivets and high-speed riveting.

FIG. 21 shows the uncured rivbond. Almost all adhesive was pressed out of joint.

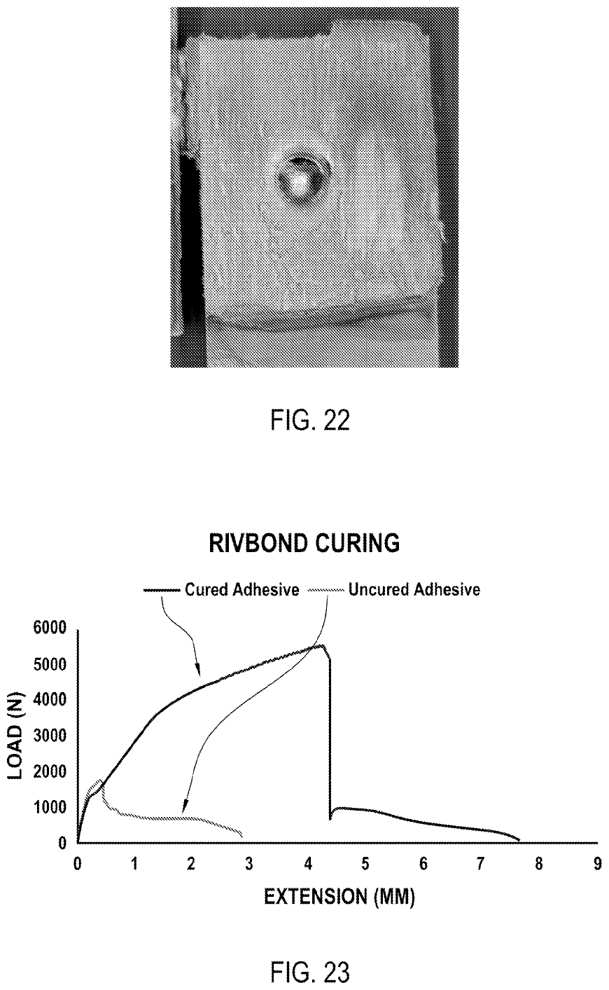

FIG. 22 shows the cured rivbond joint. Shows typical failure with layers of superwood attached to adhesive and rivet pull out.

FIG. 23 shows the cured vs uncured adhesive curves.

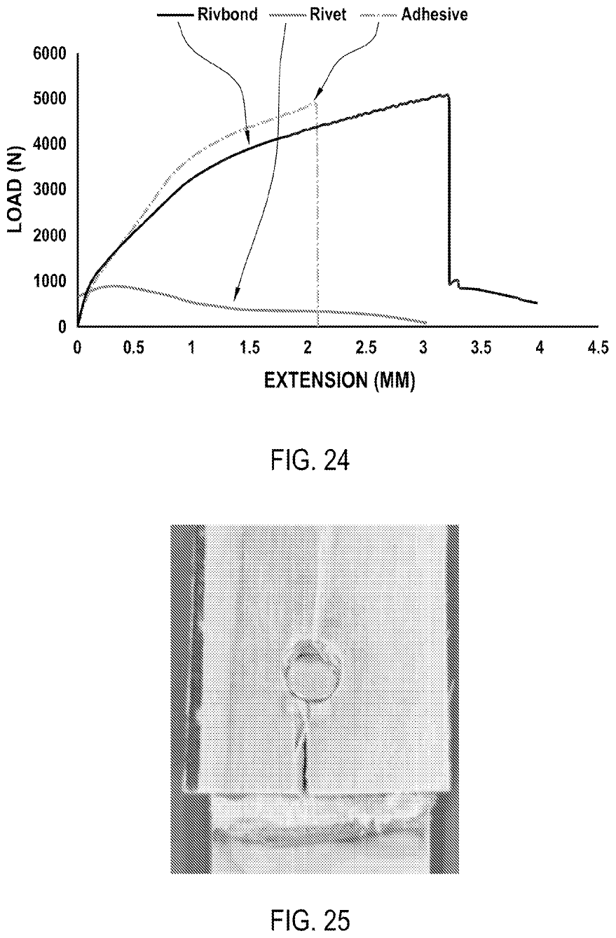

FIG. 24 shows the rivet, rivbond, and adhesive comparison.

Failure modes. All samples showed either top sheet failure or failure to join. Failure to join can be seen in samples that failed to flare properly in the bottom sheet leading to very low maximum loads. This was most common in the low-speed riveting, and was frequently caused by rivet bulging.

Top sheet failure was the most common failure method and can be split into three categories, top sheet tearing, crack creation, and crack expansion. Top sheet tearing in superwood involves the rivet crushing the superwood fibers around the rivet hole and cutting through the material. As the stack undergoes tension, the rivet head is pulled from a position parallel to the top sheet surface as the top sheet exerts force on the underside of the head. This allows the head to pull through the top sheet at an angle, leaving an oblong rivet hole. Crack creation is a failure mode where the rivet does not pull through the top sheet, but instead to relieve the stress in the superwood cracks form around the 3 and 9 o'clock positions of the rivet. These cracks propagate to the bottom edge of the top sheet creating a loose section of material under the rivet. When the loose area is the same width as the rivet, the sample fails. Crack expansion occurs when there is a pre-existing crack below the rivet. As the test progresses, this crack opens until it reaches a point that the rivet can pull through.

Most failures include some combination of the above and rivet pull-out. Rivet pull-out occurs when the rivet is pulled free of the bottom sheet during testing.

FIG. 25 shows top sheet tearing—the rivet is pulled through the top sheet.

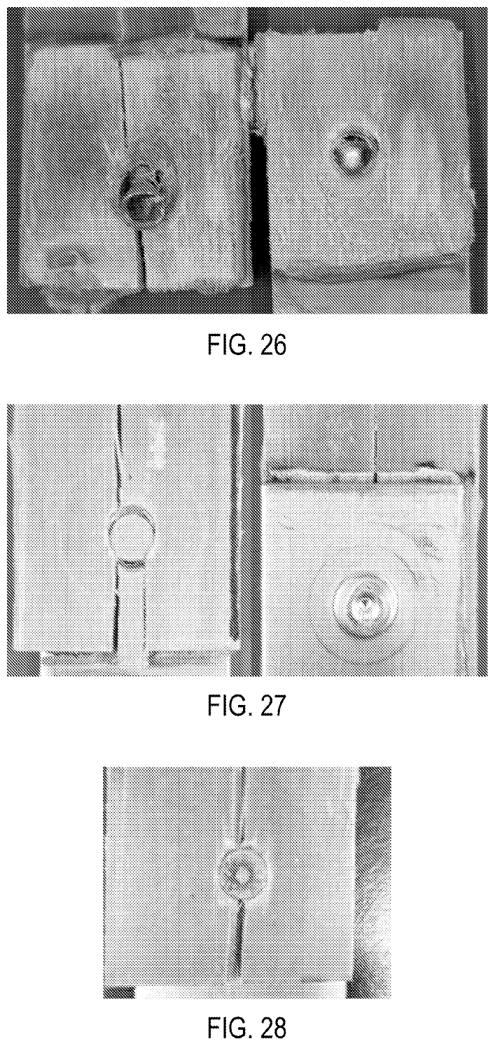

FIG. 26 shows rivet pull out in conjunction with top sheet tearing.

FIG. 27 shows crack creation.

FIG. 28 shows crack expansion.

Fracture analysis. In the superwood, fractures always propagate along the fiber direction. However, they do occur at different angles through the thickness of the wood. Looking at the low-speed rivets, four crack patterns can be seen. The first are cracks that pass vertically through the thickness of the wood. The second is samples that are vertical through s portion of the thickness before continuing the rest of the thickness at an approximately 45-degree angle. The third pattern is a switchback, where the crack travels at a 45-degree angle for half the thickness, then changes to a negative 45-degree angle for the other half to have the crack start and end vertical from each other. The final pattern is a 60-degree angle through the thickness of the wood with no bends. These differences are likely due to inherent differences in the wood due to it being a natural material with unpredictable flaws. The cracks have no discernable effect on the maximum load of the joint, but a change in crack direction does correlate to a larger extension length.

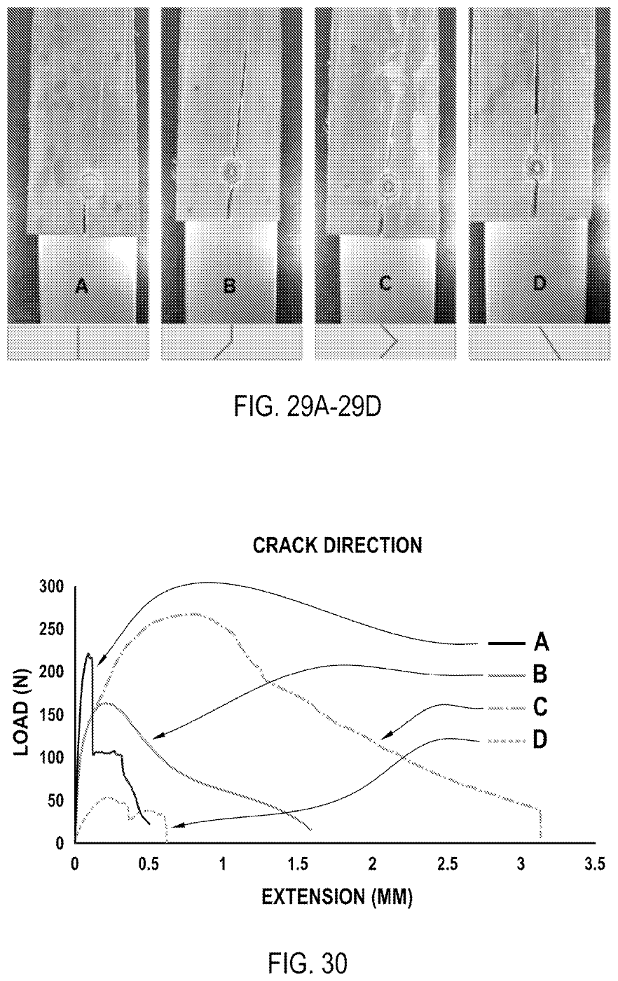

FIG. 29A-FIG. 29D. Cracked samples with illustration of crack pattern through thickness of superwood.

FIG. 30 shows curves for different cracking patterns.

Cross-sectional analysis. To determine the quality of the joint, the cross section can be used to determine the head height, bottom sheet thickness, and flare, as well as any rivet failures that could cause poor joining that are not outwardly visible in the joint. Cross sections were taken across the fiber direction to examine joint quality in the superwood-aluminum stack.

Cross sections taken of the low-speed samples show rivet bulging in all three rivet types, along with flush head heights. The bottom sheet thickness and flare could not be accurately measured in low-speed samples due to the poor joint quality causing the rivet to fall out of the joint during cross sectioning. The head height is known for these joints as it can be measured before cross sectioning.

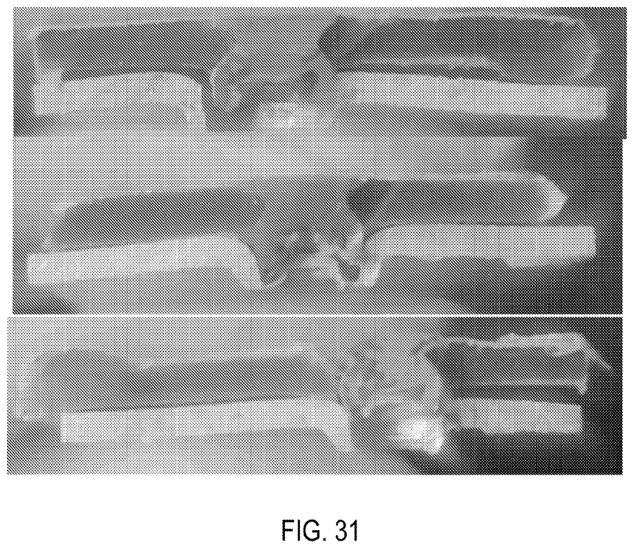

FIG. 31 shows low Speed Rivet cross section J, P, R. All buckled, poor joint caused rivets to fall from joint during sectioning.

High-speed joint cross sections were taken for all three rivet types, both pure rivet and rivbonded. The R type rivets showed bulging in the riveted joint, though that was corrected in the rivbonded joint.

With the standard riveted joints, the flare averaged 0.167 mm. The flare for 3 mm diameter rivets should be greater than. 1 mm to be considered acceptable for aluminum and steel joints. It should be noted that the flare measured is the average of the right and left side flare of the cross section as rivet joints are rarely perfectly symmetrical. The bottom sheet thickness averaged 0.456 mm. This thickness is sufficient to ensure there is no break through of the rivet through the bottom sheet. The head thickness was an average of 0.567 mm. This height is proud, while generally it is preferred to have rivets flush or under-flush to prevent any issues with other panels during production, with superwood it was found that a proud rivet head reduced cracking of the superwood.

Rivbonding altered the flare significantly, with an average of 0.334 mm flare. The bottom sheet thickness remained similar to pre riveting at 0.429 mm with head height reducing to 0.479 mm. These changes are due to the slight change in stack height caused by the adhesive and the change in the stiffness of the material between the superwood, adhesive, and aluminum.

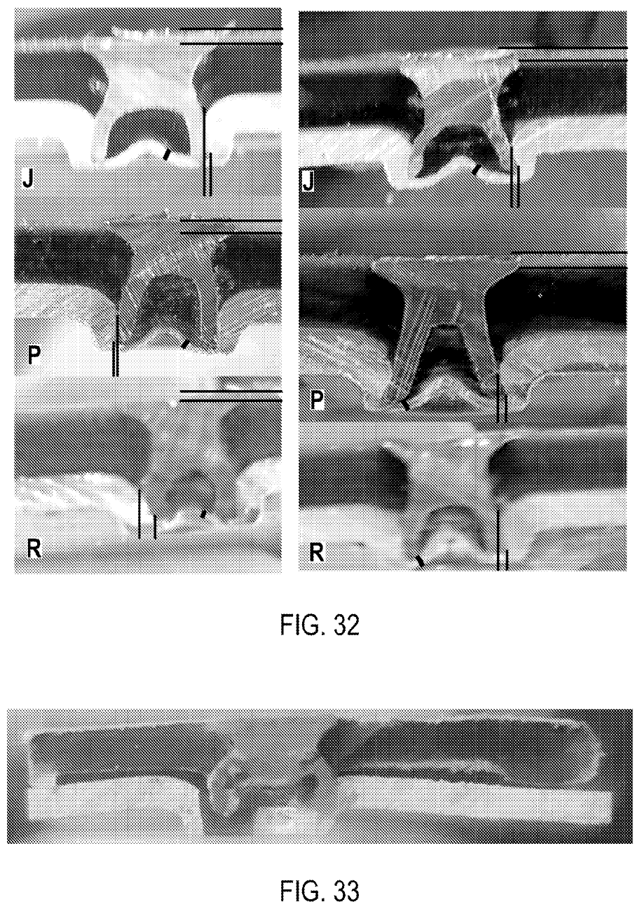

FIG. 32. Left: Rivet, Right: Rivbond. Marked with head height, flare, and bottom thickness.

| | | Bottom | Head | | | Bottom | Head |
|---|---|---|---|---|---|---|---|
| Rivet | Flare | Thickness | Height | Rivbond | Flare | Thickness | Height |
| J1 | 0.223 | 0.556 | 0.742 | J1 | 0.4 | 0.347 | 0.402 |
| | 0.148 | 0.668 | 0.705 | | 0.267 | 0.382 | 0.497 |
| J2 | 0.221 | 0.487 | 0.607 | J2 | 0.312 | 0.429 | 0.339 |
| | 0.161 | 0.47 | 0.669 | | 0.542 | 0.485 | 0.307 |
| P1 | 0.149 | 0.355 | 0.581 | P1 | 0.434 | 0.493 | 0.522 |
| | 0.194 | 0.392 | 0.616 | | 0.492 | 0.349 | 0.608 |
| P2 | 0.281 | 0.394 | 0.508 | P2 | 0.378 | 0.458 | 0.613 |
| | 0.047 | 0.311 | 0.594 | | 0.191 | 0.42 | 0.66 |
| R1 | 0.083 | 0.374 | 0.496 | R2 | 0.318 | 0.442 | 0.486 |
| | −0.504 | 0.622 | 0.248 | | 0.063 | 0.493 | 0.361 |
| Average | 0.167444 | 0.4629 | 0.5766 | Average | 0.3397 | 0.4298 | 0.4795 |

### DISCUSSION

Bonding Process Parameters to Joint Strength. The rivet geometry was shown to have a strong effect on the cracking behavior of superwood during rivet insertion, with R type rivets showing severe cracking. This is due to the bluntness of the rivets. The rivets with a sharper angle are able to cut through the wood fibers when cutting across the wood grain and the taper of the rivet gently separates the fibers for the rivet to travel between at sections that are along the grain. The blunt rivets crush the fibers rather than cut them and the lack of taper to separate fibers gently causes the wood to crack in order for the rivet to pass through the wood. These cracks then quickly propagate as the thicker sections of the rivet near the head further separate the edges of the crack.

The cross sections of the rivets further show R-type rivets to be unsuitable for superwood. The largest joint quality failures were found in joints with R rivets, including rivet bulging. Bulged rivets fail to flare out, instead bending inward. This causes a very weak joint, and can cause sheet separation, as seen in some samples of R riveting that had a joint weak enough that it broke before testing could be done.

J and P type rivets were seen to perform similarly. J rivets had better performance in low-speed riveting, with 80% higher maximum load and 160% higher extension. The difference in performance is much lower in high-speed riveting, with only a 1.2% increase in maximum load and very similar maximum extension. The vast difference in low-speed riveting again comes to rivet geometry, with the blunter P-type rivets causing more cracking in the wood. The high-speed shows less of this difference as the cracking is speed dependent.

High speed riveting shows a significant increase in joint strength and energy absorption compared to the low-speed riveting. The speed dependence of the cracking causes low speed joints to be weakened by large cracks. The low-speed cross sections also show severe bulging in all rivet types, leading to weak joints regardless of rivet. This could possibly be mitigated with a more severe pip to encourage flaring, but that would risk having the bottom sheet stretched too thin in the button area causing failure in that method without changing the sheet thickness. To increase the bottom sheet thickness would alter the stack height and could cause a cascade of further problems requiring new rivet lengths and top sheet thicknesses to correct any further issues, so changing the pip height to improve low speed riveting was not explored.

Another issue with the low-speed rivets is the head height. The low-speed rivets all have a head flush with the top sheet. With superwood, flush head height is shown to increase the cracking of the wood due to the increased diameter of material being pressed into the wood around the head of the rivet. The method recommended by the Rivlite manufacturer to increase head height would require permeant modification of the rivet setter, so the head height was not further explored in low-speed riveting.

Rivbonding Parameters to Joint Strength. Rivbonding was explored as a method to improve the rivet strength without modifying the parameters of die, insertion speed, rivet geometry, and material thickness. While adding the adhesive does increase stack height, the difference is negligible. The adhesive is shown to greatly improve energy absorption of the joint.

Standard practice of rivbonding has the rivet inserted immediately after the adhesive is applied, before the adhesive has cured. Tests of this process with superwood showed that the freshly applied adhesive was forced from the joint by the pressure of the rivet insertion, leaving minimal adhesive in the joint. The joint created slightly outperforms the plain rivet due to the remaining adhesive, but the difference is minimal. When allowing the adhesive time to cure, it greatly improves the rivet performance, creating a joint with a high failure load similar to pure adhesive but with much higher extension and energy absorption. The drawback to this process is the increased production time, though that could be reduced using a heat curing adhesive rather than a time curing one or riveting when the adhesive is partially cured.

Conclusions. Self-pierce riveting provides a convenient way to join dissimilar materials without needing to predrill holes or search for an adhesive that performs well with both adherends. This method can be used to join superwood to metals such as aluminum. The use of J-type rivets with 3 mm diameter and 6 mm length allow for a strong bond between sheets of superwood and aluminum, with joint strengths of 1400 N. This can be improved using a methacrylate adhesive to rivbond the sheets together, creating a joint with a 6000N joint strength, higher than pure rivet, and energy absorption higher than pure adhesive.

Using cross sectional analysis, the joints can be characterized to determine the suitability of different rivet designs and insertion speeds, with blunt rivets and low insertion speeds showing bulging of the rivet preventing strong bonds. The rivbonding can be seen to improve the flaring of the rivet in the stack, showing it provides more to the joint strength than just the adhesive bond.

### REFERENCES

[1] J. C. C. Z. S. Z. M. D. J. R. U. L. Y. K. Y. L. Y. Q. N. Y. Y. G. A. L. U. H. Song, H. A. Bruck, J. Y. Zhu, A. Vellore, H. Li, M. L. Minus, Z. Jia, A. Martini, T. Li and L. Hu, “Processing Bulk Natural Wood into a High-Performance Structural Material,” Nature, pp. 224-228, 2018.
[2] T. Barnes and I. Pashby, “Joining techniques for aluminium spaceframes used in automobiles. Journal of Materials Processing Technology,” Journal of Materials Processing Technology, pp. 72-79, 2000.
[3] D. Li, A. Chrysanthou, I. Patel and G. J. Williams, “Self-piercing riveting—a review,” The International Journal of Advanced Manufacturing Technology, 2017.
[4] A. Gay, F. Lefebvre, S. Bergamo, F. Valiorgue, P. Chalandon, P. Michel and P. Bertrand, “Fatigue performance of a self-piercing rivet joint between aluminum and glass fiber reinforced thermoplastic composite,” International Journal of Fatigue, pp. 127-134, 2016.
[5] R. Haque, “Quality of self-piercing riveting (SPR) joints from cross-sectional perspective: A review,” Archives of Civil and Mechanical Engineering, pp. 83-93, 2018.
[6] M. Karim, J. Bae, D. Kam, C. Kim and W. Choi, “Assessment of rivet coating corrosion effect on strength degradation of CFRP/aluminum self-piercing riveted joints,” Surface and Coatings Technology, vol. 393, 2020.
[7] M. A. Karim, T. Jeong, W. Noh, K. Park, D. Kam, C. Kim, D. Nam, H. Jung and Y. Park, “Joint quality of self-piercing riveting (SPR) and mechanical behavior under the frictional effect of various rivet coatings,” Journal of Manufacturing Processes, vol. 58, pp. 466-477, 2020.
[8] J.-H. Deng, F. Lyu, R.-M. Chen and Z.-S. Fan, “Influence of die geometry on self-piercing riveting of aluminum alloy AA6061-T6 to mild steel SPFC340 sheets,” Advances in Manufacturing, 2019.
[9] R. Haque and Y. Durandet, “Strength prediction of self-pierce riveted joint in cross-tension and lap-shear,” Materials and Design, vol. 108, pp. 666-678, 2016.
[10 ] R. Haque, J. Beynon and Y. Durandet, “Characterisation of force-displacement curve in self-pierce riveting,” Science and Technology of Welding and Joining, vol. 17, no. 6, pp. 476-488, 2012.
[11 ] X. He, L. Zhao, C. Deng, B. Xing, F. Gu and A. Ball, “Self-piercing riveting of similar and dissimilar metal sheets of aluminum alloy and copper alloy,” Materials and Design, vol. 65, pp. 923-933, 2015.
[12] X. He, Y. Wang, Y. Lu, K. Zeng, F. Gu and A. Ball, “Self-piercing riveting of similar and dissimilar titanium sheet materials,” International Journal of Advanced Manufacturing Technology, vol. 80, pp. 2105-2115, 2015.
[13] C.-S. Chung and H.-K. Kim, “Fatigue strength of self-piercing riveted joints in lap-shear specimens of aluminum and steel sheets,” Fatigue and Fracture of Engineering Materials and Structures, vol. 39, pp. 1105-1114, 2016.
[14] A. Y., T. Kato and K. Mori, “Joinability of aluminium alloy and mild steel sheets by self piercing rivet,” Journal of Materials Processing Technology, vol. 177, pp. 417-421, 2006.
[15] Y. Ma, M. Lou, Y. Li and Z. Lin, “Effect of rivet and die on self-piercing rivetability of AA6061-T6 and mild steel CR4 of different guages,” Journal of Materials Processing Technology, vol. 251, pp. 282-294, 2018.
[16] G. Di Franco, L. Fratini and A. Pasta, “Analysis of the mechanical performance of hybrid (SPR/bonded) single-lap joints between CFRP panels and aluminum blanks,” International Journal of Adhesion and Adhesives, vol. 41, pp. 24-32, 2013.
[17] F. Moroni, “Fatigue behaviour of hybrid clinch-bonded and self-piercing rivet bonded joints,” The journal of adhesion, vol. 95, no. 5-7, pp. 577-594, 2019.
[18] H. M. Rao, J. Kang, G. Huff and K. Avery, “Structural Stress method to evaluate fatigue properties of similar and dissimilar self-piercing riveted joints,” Metals, 2019.
[19] H. M. Rao, J. Kanng, G. Huff, K. Avery and X. Su, “Impact of Rivet Head Height on the Tensile and Fatigue Properties of Lap Shear Self-Pierced Riveted CFRP to Aluminum,” SAE International Journal of Materials and Manufacturing, vol. 10, no. 2, pp. 167-173, 2017.
[20] H. Rao, J. Kang, G. Hufff and K. Avery, “Impact of specimen configuration on fatigue properties of self-piercing riveted aluminum to carbon fiber reinforced polymer composite,” International Journal of Fatigue, vol. 113, pp. 11-22, 2018.
[21] J. Wang, G. Zhang, X. Zheng, J. Li, X. Li, W. Zhu and J. Yanagimoto, “A self-piercing riveting method for joining of continuous carbon fiber reinforced composite and aluminum alloy sheets,” Composite Structures, vol. 259, 2021.
[22] G. Di Franco, L. Fratini and A. Pasta, “nfluence of the distance between rivets in self-piercing riveting bonded joints made of carbon fiber panels and AA2024 blanks,” Materials and Design, vol. 35, pp. 342-349, 2012.
[23] X. Zhang, X. He, F. Gu and A. Ball, “Self-piercing riveting of aluminum-lithium alloy sheet materials,” Journal of Matreials Processing Technology, vol. 268, pp. 192-200, 2019.
[24] H. Q. Ang, “An Overview of Self-Piercing Riveting Process with a focus on Joint Failures, Corrosion Issues and Optimization Techniques,” Chinese Journal of Mechanical Engineering, 2021.
[25] Henrob Atlas Copco recommended specification for self piercing rivets (SPR) in automotive applications

### Example 3-Operating Procedure for Superwood Joining

All sample sizes given are for lap shear samples. Adhesive recipe given as wood-Al, wood-wood follows same steps.

### Adhesive

1. Prepare samples of 2.7 mm thick superwood and 2 mm thick A15754 into 25.4×101.6 mm (1×4 in) strips.
2. Abrade the surface to be adhered with 320 grit sandpaper, being sure to move the sample during sanding to ensure randomly oriented scratches left on surface.
3. Mark off the intended adhesive surface, for lap shear 25.4×25.4 mm (1×1 in).
4. Apply Plexus MA832 to the aluminum surface in an x pattern to ensure adequate coverage of the entire surface.
5. Add 0.254 mm (10 mil) glass bead spacers to ensure even layer height.
6. Place the superwood over the adhesive and press down to spread the adhesive and squeeze out excess.
7. Remove excess adhesive from the edges of the sample with paper towel.
8. Apply 1334 N (300 lbf) to the sample using a one handed bar clamp placed over the adhesive area.
9. Allow to cure for 24 hours.

### High Speed Riveting

1. Prepare samples of 2.7 mm thick superwood and 2 mm thick A15754 into 5.4×101.6 mm strips.
2. Prepare the riveting machine (Henrob 33-00045 servo electric tool rivet setter) with a DZ07-025 die.
3. Load the machine with J30644C rivets.
4. Set sample over die, with die center being center of 25.4×25.4 mm overlap area, ensuring aluminum is against the die and superwood is facing the rivet insertion mechanism.
5. Insert rivet at 145 mm/s. (approx. 33 kN force)
6. Check rivet button for any cracking or breakthrough.

### Low Speed Riveting

1. Prepare samples of 2.7 mm thick superwood and 2 mm thick A15754 into 25.4×101.6 mm strips.
2. Prepare the riveting machine (Henrob Rivlite) with a DZ07-025 die.
3. Load the machine with J30644C rivets.
4. Set sample over die, with die center being center of 25.4×25.4 mm overlap area, ensuring aluminum is against the die and superwood is facing the rivet insertion mechanism.
5. Insert rivet at 35 kN force (approx. 60 mm/s)
6. Check rivet button for any cracking or breakthrough.

### Rivbond

Follow steps for adhesive, then for rivet high or low speed.

High speed vs low speed results. High speed riveting shows a significant increase in joint strength and energy absorption compared to the low-speed riveting.

The low-speed cross sections show severe bulging in all rivet types, leading to weak joints regardless of rivet.

The low-speed rivets all have a head flush with the top sheet. High-speed rivets show a proud head height of average 0.58 mm.

FIG. 33 shows low speed rivet showing buckling behavior.

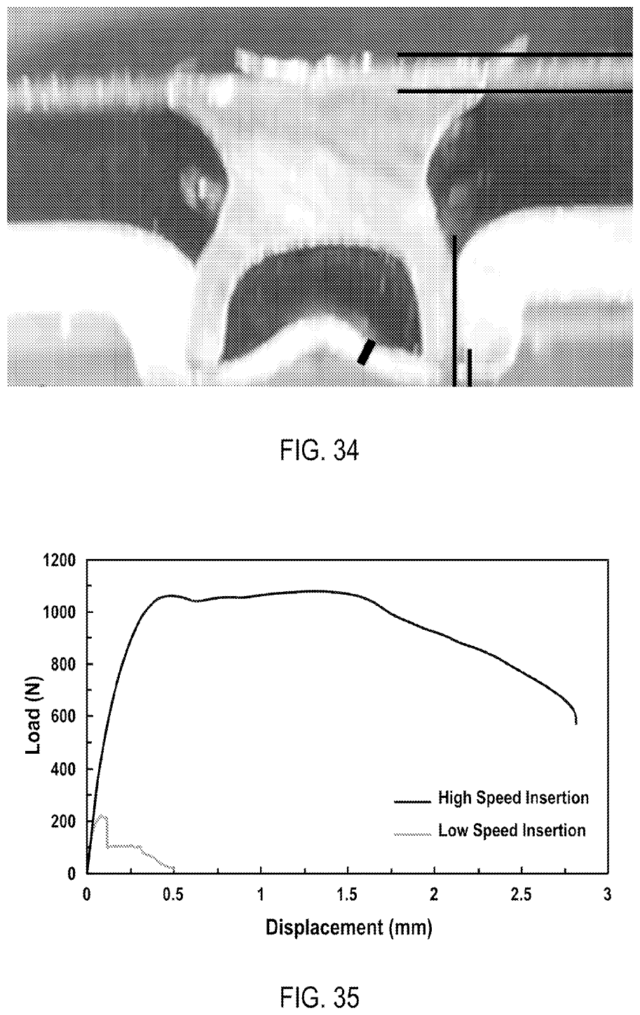

FIG. 34 shows high speed rivet showing no buckling and a proud head height.

FIG. 35 shows high-speed vs low-speed load-displacement curves. High-speed show much higher energy absorption, with a maximum load of 1070 N compared to low-speed with a max load of 210N.

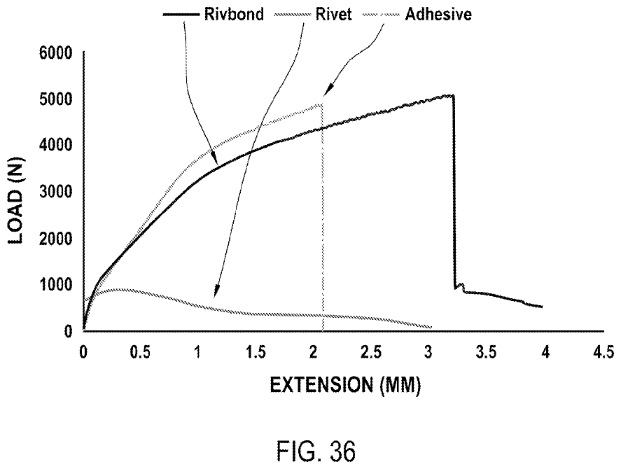

FIG. 36 shows load-extension curves for pure rivet, pure adhesive, and rivbonding (high-speed).

TABLE 1
Comparison of average head height, bottom sheet thickness, and
flare to baseline Steel-Al parameters reported as ideal for automotive
joining in Atlas Copco Specifications for Automotive Application.
Measurements taken from high-speed insertions.

| | Head Height | Bottom Sheet | Flare | |
|---|---|---|---|---|
| Steel-Al | Flush | No breakthrough | >0.1 | mm |
| SW-Al | 0.567 mm | 0.456 mm | 0.167 | mm |
| Rivbond SW-Al | 0.479 mm | 0.429 mm | 0.334 | mm |

### Example 4-Joining Methods for Densified Wood Using Self-Piercing Riveting in Conjunction with Adhesive Bonding

Wood materials have been improved, i.e., chemically altered and densified, to provide significantly higher strength than natural wood, comparable to metallic materials commonly used in structural applications in automotive and other transportation industries [1]. In order to make wood materials in structural applications in manufacturing, they need to be joined with dissimilar materials such as metals.

### THE TECHNOLOGY

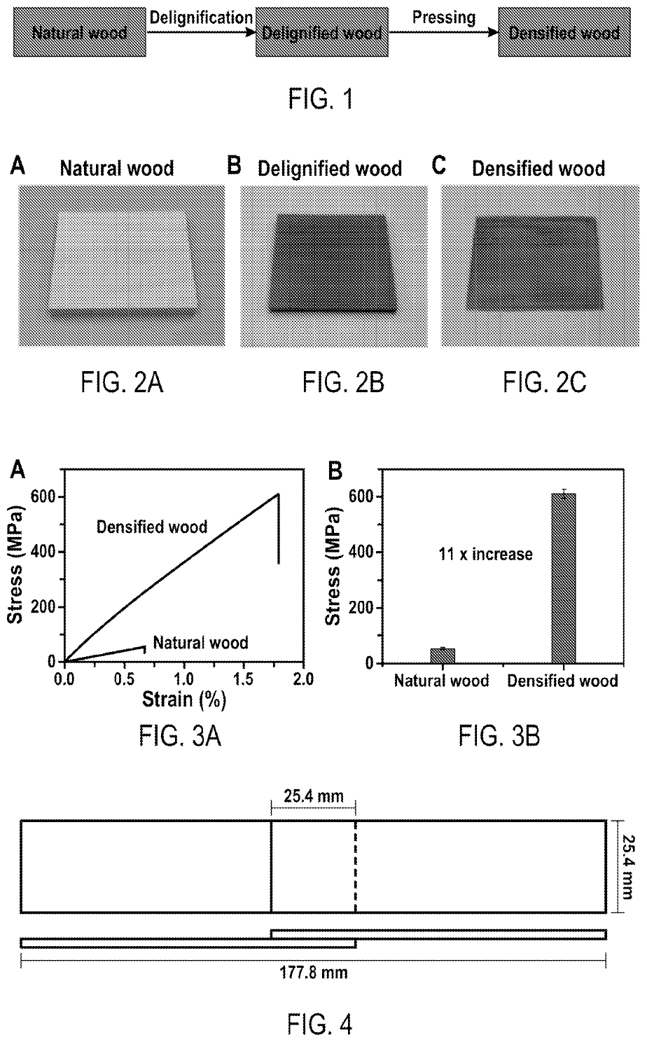

Wood treatment. A two-step process is used to fabricate the densified wood, as shown in FIG. 1. In the first embodiment, natural wood (FIG. 2A) and the chemical solution are put into a 2L reactor, and heated at 100-180° C. for 1 to 4 hours to obtain the delignified wood (FIG. 2B).

The nature wood can be either softwood or hardwood, such as, but not limited to, basswood, oak, poplar, ash, alder, aspen, balsa wood, beech, birch, cherry, butternut, chestnut, cocobolo, elm, hickory, maple, padauk, plum, walnut, willow, yellow poplar, bald cypress, cedar, cypress, douglas fir, hemlock, larch, pine, redwood, spruce, tamarack, juniper, and yew.

The chemical solution used include at least one of NaOH (LiOH or KOH), NaOH/Na2O+Na2SO3/Na2SO4, NaOH/Na2O+Na2S, NaHSO3+SO2+H2O, NaHSO3+Na2SO3, NaOH/Na2O+Na2SO3, NaOH//Na2O+AQ, NaOH/Na2O+Na2S+AQ, NaOH/Na2O+Na2SO3+AQ, Na2SO3+NaOH/Na2O+CH3OH+AQ, NaHSO3+SO2+AQ, NaOH/Na2O+Na2Sx, NaOH/Na2O+02, where AQ is Anthraquinone.

In the second embodiment, the delignified wood is pressed into super wood (FIG. 2C) using a presser under the pressure of 5-20 MPa at 105° C.

The resulting super wood shows a strength of 600 MPa, which is about 10 times than that of natural wood (FIGS. 3A-3B).

Surface Preparation. Surface preparation is foundational to any adhesive based joining method. Based in traditional woodworking methods [2], the superwood is treated by polishing the bonding surface with sandpaper. In traditional woodworking, surfaces are prepared using sandpaper of 60-80 grit to create a smooth, knife-cut surface for the adhesive bonding. Lower grits crush the cells preventing adhesive penetration, while higher grits created fuzzed surfaces which affect wetting. Sandpaper of 320 grit was found best for superwood and is used to create randomly oriented scratches along the wood surface to increase the surface area available for adhesion and to open any wood cells that are not completely crushed during the densification process to allow for deeper penetration of the adhesive. The metal the superwood is bonded to is cleaned then treated in the same manner as per adhesive manufacturer recommendation.

Adhesive Bonding. The adhesive bonding stack is made of a 25.4 mm wide, 101.6 mm long, 2.7 mm thick piece of superwood adhered to a 25.4 mm wide, 101.6 mm long, 2 mm thick piece of metal, typically aluminum, with a 25.4 mm square overlap area, seen in FIG. 4. Methacrylate adhesive is applied to the bonding surface of the aluminum. This adhesive has 10 mil glass bead spacers added to ensure an even layer thickness across the sample. The superwood is then adhered to the aluminum. Excess adhesive is removed from edges of the assembled stack, and the stack is left to cure for 24 hours with 300 lbf clamps holding the joint in place and assisting in pressing adhesive further into the superwood.

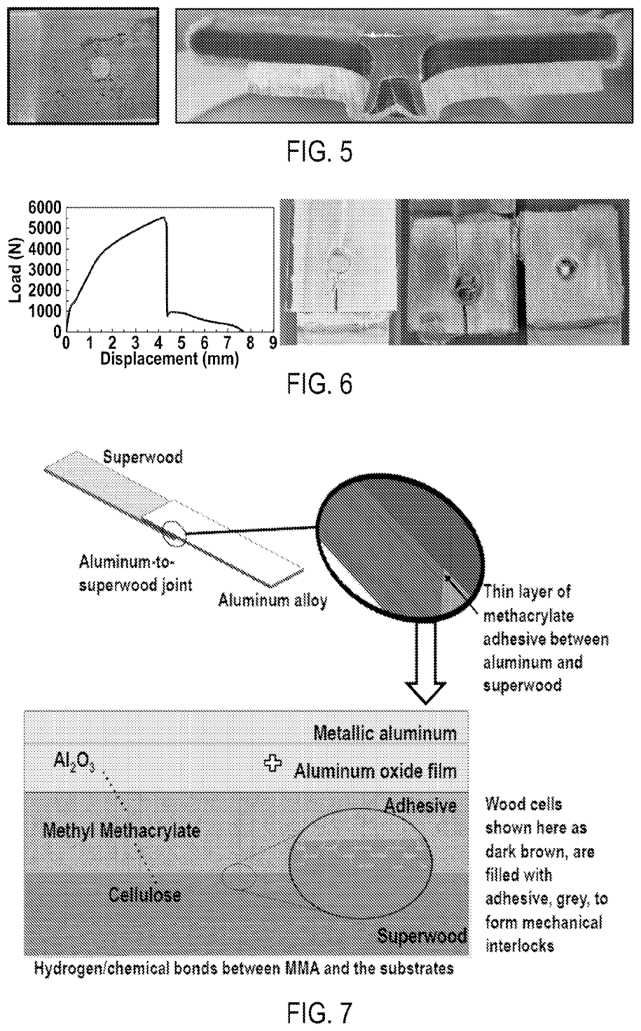

Self-Pierce Riveting. Self-pierce riveting is a process that alloys for a mechanical joint to be created without the need for pre-drilled pilot holes. J-type rivets are used, which have a medium bluntness at the tip, allowing the rivet to shear through wood fibers rather than spread them apart and cause cracking. The cylindrical rivet is pressed into a stack of material at a speed of 145 mm/s and is deformed by the die that sits underneath the stack in the rivet machine which forces the rivet to spread open and create a strong mechanical joint. In the case of the superwood-metal bond, the adhered stack is placed on the riveting machine with the superwood facing the rivet insertion mechanism and the metal facing the die and riveted with a 3 mm diameter rivet, seen in FIG. 5.

Mechanical Properties at Room Temperature. Assembled samples were tested as per the lap shear test outlined in ASTM D1002 and D5868, the standards for single lap shear for metal and fiber reinforced plastic respectively, with the only difference being the testing speed. The samples were tested at a speed of 2 mm/min, as used in industry and falling between the speeds given in the two ASTM standards. The samples exhibit a peak load at 5583 N, which then drops to 965 N as the adhesive bond between the materials fails and the rivet becomes the primary method of joining, shown in FIG. 6. The force then slowly declines as the rivet tears through the top sheet of superwood and pulls out of the bottom sheet of aluminum. Force and displacement are used in place of stress and strain due to the constantly changing cross section over which force is being applied. The peak adhesive load shown is higher than peak loads in similar tests in natural wood. Örs et. Al showed a maximum load of 6.98 N/mm² in their experiments testing the adhesive bonding of beech with 4 different adhesives, up to 11.84 when the wood is impregnated with adhesive [3]. Tiryaki et. Al showed a load of 9.74/mm² in their practical and predictions of strength of beech using PVAc adhesive [4]. In pure adhesive tests, our methods have shown a load of 11.38 N/mm².

Commercial Applications. This joining method is designed for use in the automotive or aerospace industries, in which lightweight materials are useful to reduce vehicle weight and increase fuel efficiency.

### Benefits/Advantages

Uses technology already known in automotive, adapted to new material, allowing for easy adoption.
Allows for use of lightweight, renewable material in conjunction with common metals already in use
Matching or higher shear strength than conventional adhesive bonding strength of wood materials, depending on adhesive, wood, impregnating chemical combination.

### REFERENCES

[1] J. Song, C. Chen, S. Zhu, M. Zhu, J. Dai, U. Ray, Y. Li, Y. Kuang, Y. Li, N. Quispe, Y. Yao, A. Gong, U. H. Leiste, H. A. Bruck, J. Y. Zhu, A. Vellore, H. Li, M. L. Minus, Z. Jia, A. Martini, T. Li, and L. Hu, “Processing bulk natural wood into a high-performance structural material,” Nature, vol. 554, no. 7691, pp. 224-228, 2018.
[2] C. B. Vick, “Adhesive Bonding of Wood Materials,” in Wood Handbook-Wood as an Engineering Material, Madison, WI: U.S. Dept. of Agriculture, Forest Service, Forest Products Laboratory, 1999.
[3] Ors, Yalcin et al. “Bonding Strength Of Poly(Vinyl Acetate)-Based Adhesives In Some Wood Materials Treated With Impregnation”. Journal Of Applied Polymer Science, vol 76, no. 9, 1999, pp. 1472-1479. Wiley, doi: 10.1002/(sici) 1097-4628(20000531) 76: 9<1472::aid-app11>3.0.co;2-o.
[4] Tiryaki, Sebahattin et al. “Experimental Investigation And Prediction Of Bonding Strength Of Oriental Beech (Fagus Orientalislipsky) Bonded With Polyvinyl Acetate Adhesive”. Journal Of Adhesion Science And Technology, vol 29, no. 23, 2015, pp. 2521-2536. Informa UK Limited, doi: 10.1080/01694243.2015.1072989.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The devices and methods of the appended claims are not limited in scope by the specific devices and methods described herein, which are intended as illustrations of a few aspects of the claims and any devices and methods that are functionally equivalent are intended to fall within the scope of the claims. Various modifications of the devices and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A method of joining dissimilar materials, the method comprising joining a first material to a second material using adhesive bonding, self-piercing riveting, or a combination thereof; wherein the first material and the second material are different.

2. The method of claim 1, wherein the first material comprises wood.

3. The method of claim 1, wherein the second material comprises a metal.

4. The method of claim 1, wherein the second material comprises aluminum, magnesium, steel, or a combination thereof.

5. (canceled)

6. The method of claim 1, wherein the method comprises adhesive bonding, and wherein the adhesive bonding comprises applying an adhesive to at least a portion of the first material and/or the second material, contacting said portion with the other material, optionally applying pressure, and allowing the adhesive to cure.

7. (canceled)

8. (canceled)

9. The method of claim 6, wherein the method further comprises preparing the first material and/or the second material before applying the adhesive, wherein preparing the first material and/or the second material comprises cleaning, priming, etching, polishing, sanding, patterning, or a combination thereof.

10. The method of claim 6, wherein the adhesive comprises a methyl methacrylate adhesive.

11. The method of claim 6, wherein the adhesive comprises a time-curing adhesive, a heat-curing adhesive, or a combination thereof.

12. The method of claim 1, wherein the method comprises self-piercing riveting, and wherein the self-piercing riveting comprises stacking the first material and the second material, placing the stack on the riveting machine with the first material facing the rivet insertion mechanism and the second material facing the die, and riveting the stack with a self-piercing rivet.

13. (canceled)

14. The method of claim 12, wherein the self-piercing rivets comprise J rivets, P rivets, R rivets, or a combination thereof.

15. (canceled)

16. The method of claim 12, wherein the self-piercing rivets are inserted with an insertion force of from 20-50 kN.

17. (canceled)

18. The method of claim 12, wherein the self-piercing rivets are inserted at high speed.

19. (canceled)

20. The method of claim 12, wherein the head of the self-piercing rivet is substantially flush with surface of first material after riveting.

21. (canceled)

22. The method of claim 1, wherein the method comprises adhesive bonding and self-piercing riveting, wherein the adhesive bonding comprises applying an adhesive to at least a portion of the first material and/or the second material, contacting said portion with the other material, optionally applying pressure, and allowing the adhesive to cure, and wherein the self-piercing riveting comprises stacking the first material and the second material, placing the stack on the riveting machine with the first material facing the rivet insertion mechanism and the second material facing the die, and riveting the stack with a self-piercing rivet.

23. The method of claim 22, wherein self-piercing riveting is performed after adhesive bonding.

24. The method of claim 23, wherein the adhesive is cured before performing self-piercing riveting.

25. (canceled)

26. A device comprising the dissimilar materials joined by the method of claim 1.

27. A method of use of the dissimilar materials joined by the method of claim 1, wherein the method comprises using the joined dissimilar materials in an automotive application.

28. (canceled)

29. The method of claim 1, wherein the first material comprises superwood.

30. The method of claim 6, wherein the adhesive is Plexus MA832.
